(19) United States
(12) Patent Application Publication
(10) Pub. No.: US 2026/0042036 A1
(43) Pub. Date: Feb. 12, 2026

(54) METHOD FOR SELECTIVELY EXTRACTING A SALT TO BE EXTRACTED FROM SALTWATER OR BRINE

(71) Applicant: ADIONICS, Les Ulis (FR)

(72) Inventors: Guillaume DE SOUZA, Montcourt-Fromonville (FR); Florent BOUQUET, Vulaines-sur-Seine (FR); Jim VICENS, Antony (FR); Andréa TRUJILLO, Saint Germain en Laye (FR); Lucas VERBRUGGHE, Paris (FR)

(21) Appl. No.: 19/100,829

(22) PCT Filed: Aug. 2, 2023
(86) PCT No.: PCT/IB2023/057828

§ 371 Date: Feb. 3, 2025

(30) Foreign Application Priority Data
Aug. 3, 2022 (FR) FR2208067
Feb. 27, 2023 (FR) FR2301758

(51) Int. Cl. B01D 11/04; B01D 11/00; B01D 11/02; C22B 26/12

(52) U.S. Cl. CPC B01D 11/0492; B01D 11/02; B01D 11/0434; C22B 26/12; B01D 2011/002; B01D 2252/20

(57) ABSTRACT

The present invention relates to a process for the selective extraction of a salt to be extracted from a brine to be treated containing the said salt to be extracted, characterized in that: the brine to be treated (S1) is sent to an initial extraction stirrer-mixer (1a) into which a liquid hydrophobic organic phase is also introduced, the said brine and the said liquid hydrophobic organic phase are mixed in the said initial extraction stirrer-mixer (1a), and the mixture is sent to an initial decanter-separator (1d, 1dc), in order to obtain: a brine from which salt to be extracted has been removed; and an organic phase loaded with salt to be extracted; the brine from which the salt to be extracted has been removed is recovered; the organic phase loaded with salt to be extracted is sent to an initial washing stirrer-mixer-decanter-centrifugal separator (5a, 5dc or 7a, 7dc), in order to obtain a purified organic phase loaded with salt to be extracted, which is sent to a so-called “organic” heat exchanger (1e) in which it is heated before being sent to a so-called initial “regeneration” column (1c; 2c), in which a countercurrent exchange is carried out with hot water at a higher temperature than that of the initial brine, in order to obtain: a water containing the salt to be extracted; and a regenerated organic phase, having lost the salt to be extracted; the regenerated organic phase is recycled to the initial extraction stirrer-mixer (1a).

The present invention relates to a process for the selective extraction of a salt to be extracted from a salt water or brine containing the salt to be extracted as well as other salts.

The upgrading of alkali salts, alkaline-earth salts, transition metal salts or rare earth metal salts solubilized in a natural brine or a leaching brine is still a relatively complex, costly operation with a high environmental impact, and there is still much room for improvement.

It is historically based on a separation of the various salts by crystallization depending on the temperature evolution of their respective solubilities coupled with their differences in water solubility which, for example at 50° C., follows the increasing order of the following saturation molalities: NaF<NaHCO₃≅BaCl₂<Na₂SO₄<MgSO₄<ZnSO₄<KCl<MgCl₂<NaCl<CdCl₂<MnCl₂<KNO₃<NH₄Cl<CaCl₂<CsCl<LiCl<ZnCl₂<NH₄NO₃ . . . .

Of course, for each brine to be treated, the number of ions and salts present is generally much smaller, which can lead to sufficiently large differences in solubility to improve their separation capacity. Indeed, for example, when it comes to separating alkaline and alkaline-earth salts, the implementation of solar evaporation tanks or thermal crystallization systems allows a successive precipitation of the different salts according to their initial concentration and their solubility in water. However, this generates a high degree of variability in the crystallization process, due to the variability of the mineral composition of the sources, their variability over time and the degree of concentration of the brine to be treated. This approach requires a very good knowledge of the crystallization and co-crystallization conditions of the salts involved. Despite this, the mineral salts resulting from this thermal crystallization are produced pure with low to medium yields, or are impure and require one or more additional downstream purification steps. Furthermore, given the high energy cost of water evaporation (682 kWh^{th}/ton at 20° C.), even if modern evaporation processes incorporating mechanical vapour compression and/or multiple-effect distillation are implemented industrially, this approach is still very costly in terms of energy, i.e. in the region of 20 to 60 kWh^{elect}/ton of distilled water or, in relation to the crystallized salt, an energy in the region of 100 times higher, given the need to evaporate, for example, 75 to 150 tons of water per ton of crystallized NaCl. As a result, except for applications involving salts of high economic value, solar evaporation ponds are used instead, which have the advantage of providing zero Opex in terms of water evaporation energy, at the expense of a considerable local water consumption, since more than 90% of the water in the brine to be treated is evaporated. This approach, which is acceptable for water evaporation by the sea, is much less so for operations in desert, arid or landlocked areas.

Depending on the chemical composition of the water and the metals in solution to be recovered to be upgraded, other separation strategies have been developed, in particular by hydrometallurgy, a metal treatment process by liquid route that includes a stage in which the metal is solubilized for its purification using an acid (H₂SO₄) or an oxidant (Cl₂, H₂O_{2 . . .} ). This leaching or dissolution is used in particular for a number of transition metals such as zinc, copper, nickel, cobalt, manganese, rare earths, uranium and others.

Once solubilized, some of them can be precipitated as insoluble hydroxide, carbonate or sulphide compounds. This is an approach based on precipitation. These precipitates depend essentially on the pH of the medium, the solubility products and the redox potentials of the medium. Most frequently, the pH of the solution is increased to form hydroxides that precipitate. The metal is then recovered as a solid by simple decantation, within the limit of its solubility product, which often results in concentrations at the outlet of the process that often exceed environmental discharge standards. In addition to the potential need for further treatment downstream, this approach may require large quantities of reagents (neutralizing bases and acids, or Na₂CO₃, . . . ), or generate operating difficulties due to scaling problems, or require upstream pre-treatment to enable the precipitation of a product of acceptable purity, all of which can make this approach unattractive from an economic point of view while generating large volumes of waste that is often stored in residue retention dams.

Another approach often used is the ion exchange. This involves contacting the aqueous solution with an organic material or formulation capable of exchanging the metal to be extracted, usually with a proton H⁺ or a sodium Na⁺. One disadvantage of this approach is that if the ion exchange is carried out with a Na⁺, the ion exchange resin, whether solid or liquid, undergoes an initial regeneration with acid to desorb the metal ion, then neutralization with NaOH soda before it can be used again for extraction. If the ion exchange is carried out directly in H⁺/ionic metal, the pH of the water in contact is lowered and it is also necessary to use reagents for extraction, washing and regeneration of the material (neutralization acids and/or bases), which may be in large quantities. In both these cases, this generates significant operating costs and potentially the installation of a local chlorine and caustic soda plant to produce these acids and bases. Another disadvantage may be due to the regeneration or acid washing of the ion exchange material which, if it is inorganic, may also undergo leaching and therefore its own degradation over time with potential emissions into the environment of transition and/or heavy metals Mn, Ti, Sn, Cu, Al, V or Sb, depending on the initial composition of the ion exchange material chosen. This is all the more problematic as the ecotoxicity thresholds for these metals are very low and they are difficult to trap completely.

Finally, we note the absence of a direct extraction of a neutral salt and the systematic addition of a salt/waste to the system and/or its environment, such as Na₂SO₄ resulting from the overall combination of 2 NaOH and H₂SO₄.

Another approach is the salt adsorption. This involves physically or electrochemically fixing the metal salt to the surface or inside the pores of an adsorbent material. Very few applications have been developed to date, but we can cite the selective adsorption of lithium and capacitive deionisation for the desalination of low-salinity brackish water. Naturally, adsorption is economically limited to the removal of small quantities of ions due to the very large porous adsorption surfaces required, i.e. less than 5 g NaCl/L of solution in capacitive deionisation (CDI) and less than 6.5 g LiCl/L of solution in selective extraction by adsorption.

The aim of the present invention is to obtain a technical and economic solution enabling the selective extraction of a salt to be extracted over a wide concentration range, with a high extraction yield, an energy consumption close to the theoretical minimum energy (associated with the extraction of a salt from water), an ability to produce this extracted salt in high purity, a water consumption also close to the theoretical minimum and zero consumption of reagents.

To this end, the present invention relates to a process for the selective extraction of a salt to be extracted comprising at least one cation and at least one anion from a salt water or brine to be treated containing the said salt to be extracted and salts other than the salt to be extracted, characterized in that:
the brine to be treated is sent to a so-called initial extraction stirrer-mixer into which a liquid hydrophobic organic phase is also introduced, said organic phase comprising:
   at least a first hydrophobic, protic organic compound which solvates the anion of the salt to be extracted and whose pKa in water at 25° C. is at least 9; and
   at least a second hydrophobic organic compound which selectively extracts the cation of the salt to be extracted and has a complexation constant for the cation to be extracted whose log K value, in methanol at 25° C., is greater than 1, preferably greater than 2,
said brine and said liquid hydrophobic organic phase are mixed in said extraction stirrer-mixer, and the mixture is sent to a so-called initial extraction decanter-separator, in order to obtain:
   a brine from which salt to be extracted has been removed; and
   an organic phase loaded with salt to be extracted;
the brine from which the salt to be extracted has been removed is recovered;
the organic phase leaving the initial decanter-separator is sent to a new stirrer-mixer so-called an initial washing stirrer-mixer in which it is mixed with washing water, and the mixture is sent to a decanter-centrifugal separator so-called an initial washing decanter-centrifugal separator in order to obtain:
   a purified organic phase loaded with salt to be extracted, which is sent to a so-called “organic” heat exchanger in which it is heated; and
   a washing water loaded with impurities which is sent to the initial extraction stirrer-mixer;
the organic phase loaded with salt to be extracted, heated in the so-called “organic” heat exchanger, is sent to a so-called initial regeneration column in which a countercurrent exchange is carried out with hot water at a temperature higher than that of the initial brine, in order to obtain:
   water containing the salt to be extracted; and
   a regenerated organic phase, having lost the salt to be extracted;
said organic phase loaded with the salt to be extracted being heated in the heat exchanger by the organic phase leaving the regeneration column,
the regenerated organic phase is recycled to the initial extraction stirrer-mixer.

In particular, the salt to be extracted can be extracted cold, i.e. at a temperature of between −35° C. and +45° C. The regeneration in the regeneration column then takes place at a higher temperature.

In particular, the organic phase can be washed at a temperature of between 5° C. and 45° C.

The temperature difference between the extraction and regeneration steps can be at least 30° C., preferably more than 40° C. and even more preferably more than 50° C. The regeneration steps can be carried out at a temperature of 60° C. to 150° C.

In particular, the organic phase leaving the regeneration column can be heated before entering the “organic” heat exchanger.

In particular, the first organic compound solvating the anion of the salt to be extracted can be chosen from N-(3,4-dichlorophenyl)octanamide, N-(3,5-dichlorophenyl)octanamide and N-(3,4,5-trifluorophenyl)octanamide.

In a particular embodiment, the second organic compound is a lithium cation extractant compound chosen from compounds of formula:

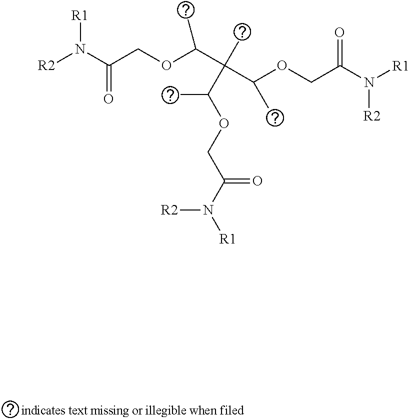

in which:
   R1 and R2, which can be identical or different, are, irrespective of their position on a nitrogen atom, independently selected from linear or branched C₁-C₁₂ alkyl, aryl, C₄-C₈ cycloalkyl; or
   R1 and R2, taken together with the nitrogen atom carrying them, form a five-, six-, seven- or eight-membered ring;
   R3 is selected from hydrogen, linear or branched C₁-C₈ alkyl, C₄-C₈ cycloalkyl, C₂-C₆ alkoxyalkyl and alkoxyalkylaryl;
   R4 is selected from hydrogen, linear or branched C₁-C₃ alkyl;
   R5 is selected from hydrogen, linear or branched C₁-C₃ alkyl;
   R6 is selected from hydrogen, linear or branched C₁-C₃ alkyl.

In a particular embodiment:
R1 and R2 can be, whatever their position on a nitrogen atom, independently selected from methyl, ethyl, n-propyl, iso-propyl, n-butyl, iso-butyl, sec-butyl, tert-butyl, n-pentyl, iso-pentyl, 2-methylbutyl, 2-ethylpropyl, n-hexyl, n-heptyl, n-octyl, n-nonyl, n-decyl, 2-ethylhexyl, phenyl, cyclobutyl, cyclopentyl, cyclohexyl, cycloheptyl, cyclooctyl; or,
R1 and R2, taken together with the nitrogen atom carrying them, can form a pyrrolidine, piperidine, azepane or azocane ring;
R3 can be selected from hydrogen, methyl, ethyl, propyl, iso-propyl, n-butyl, iso-butyl, sec-butyl, tert-butyl, n-pentyl, iso-pentyl, 2-methylbutyl, 2-ethylpropyl, n-hexyl, cyclohexyl, methoxymethyl, methoxyethyl, methoxypropyl, methoxybutyl and —CH₂—O—CH₂-Phenyl; and
R4, R5 and R6 can be hydrogen or methyl,
   R1 and R2 being advantageously chosen from butyl, pentyl, hexyl, heptyl, octyl, nonyl, decyl or phenyl if the brine to be treated has a calcium concentration of more than 10 g/L and/or the Li⁺/Ca²⁺ selectivity is preferred; and
   R1 and R2 being advantageously chosen from iso-propyl, iso-butyl, sec-butyl, tert-butyl, iso-pentyl, 2-methylbutyl, 2-ethylpropyl, cyclobutyl, cyclopentyl, cyclohexyl, cycloheptyl, cyclooctyl or R1 and R2, taken together with the nitrogen atom carrying them, form a pyrrolidine, piperidine, azepane or azocane ring when the brine to be treated has a calcium concentration of less than 10 g/L and/or when Li⁺/Na⁺ selectivity is preferred.

The lithium cation extractant compound can be selected from, but is not limited to:

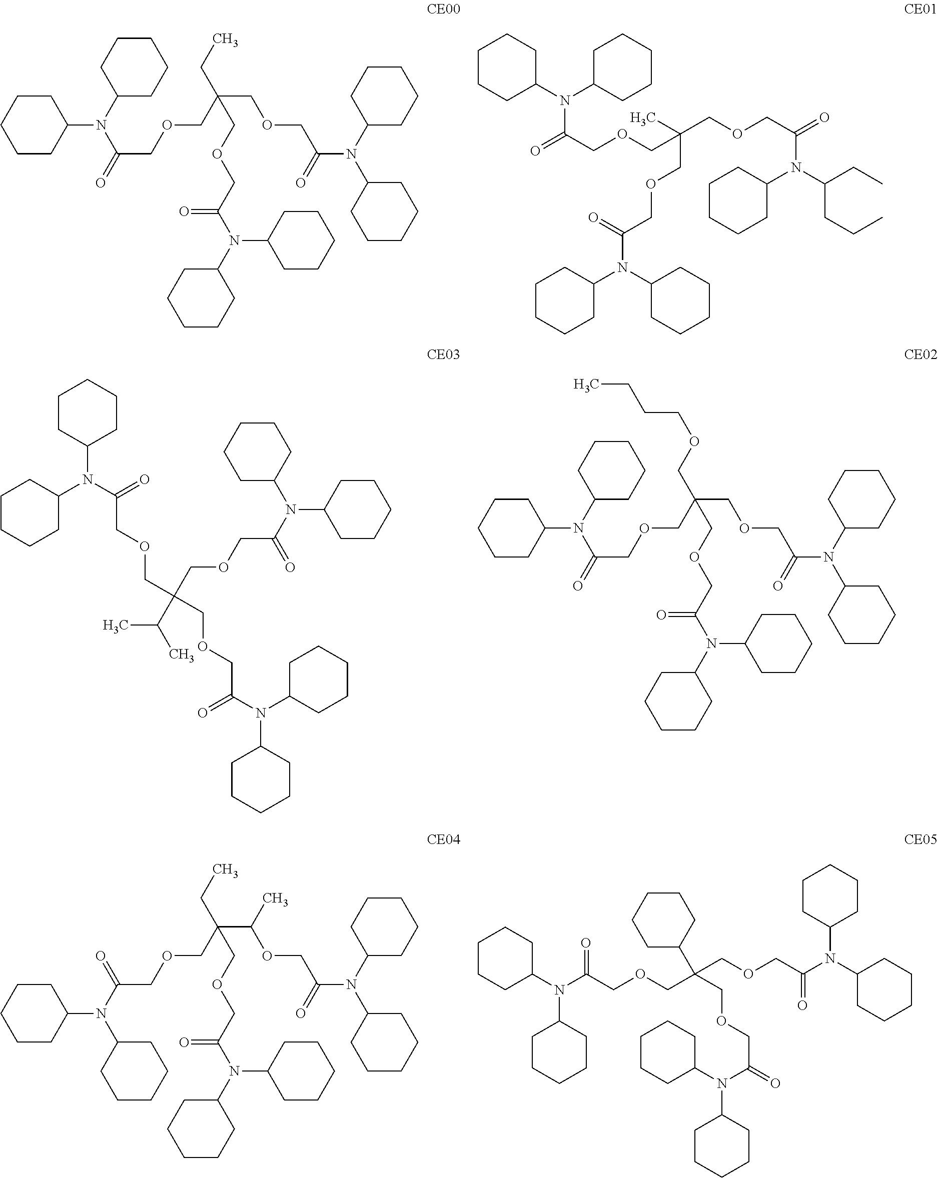

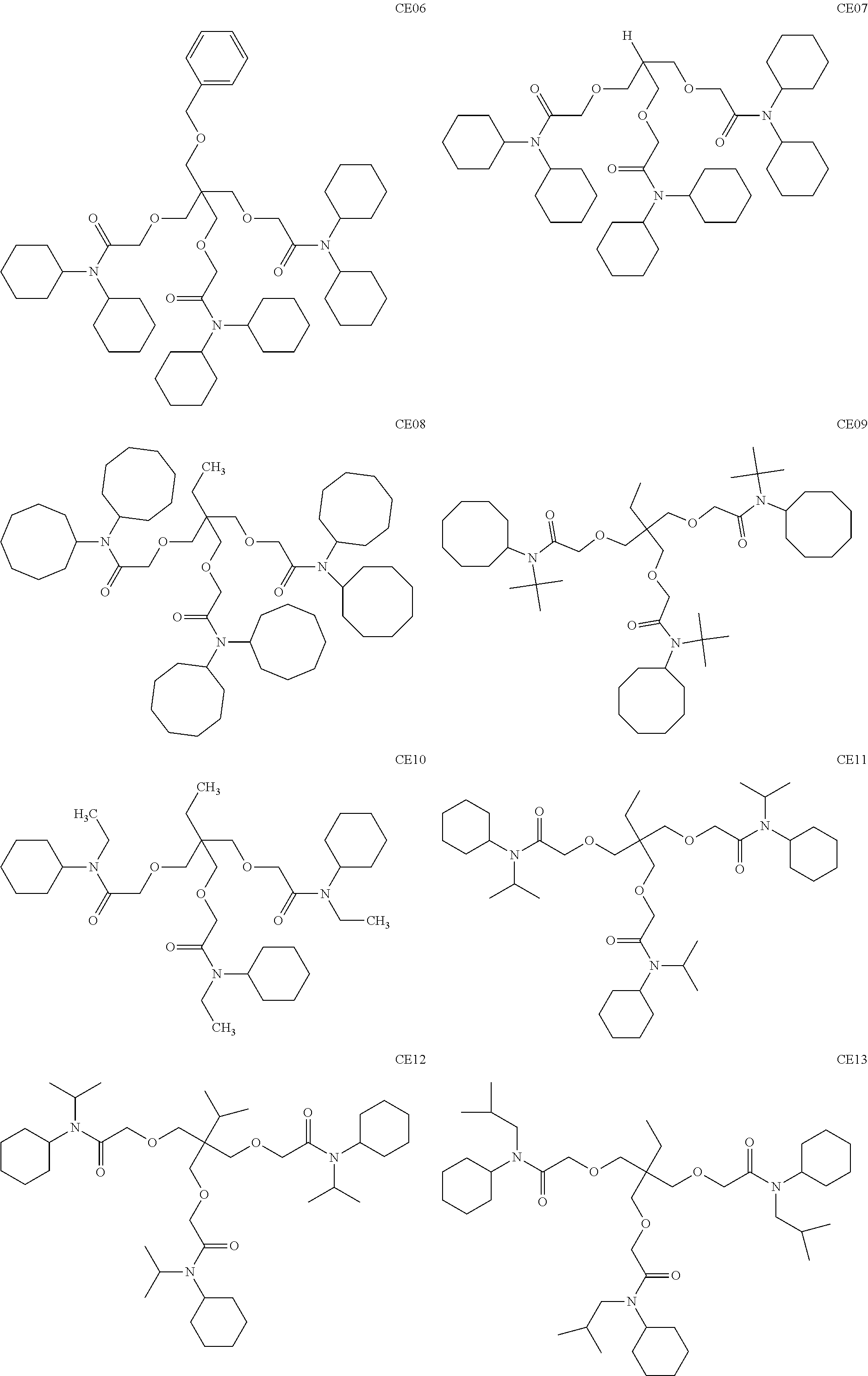

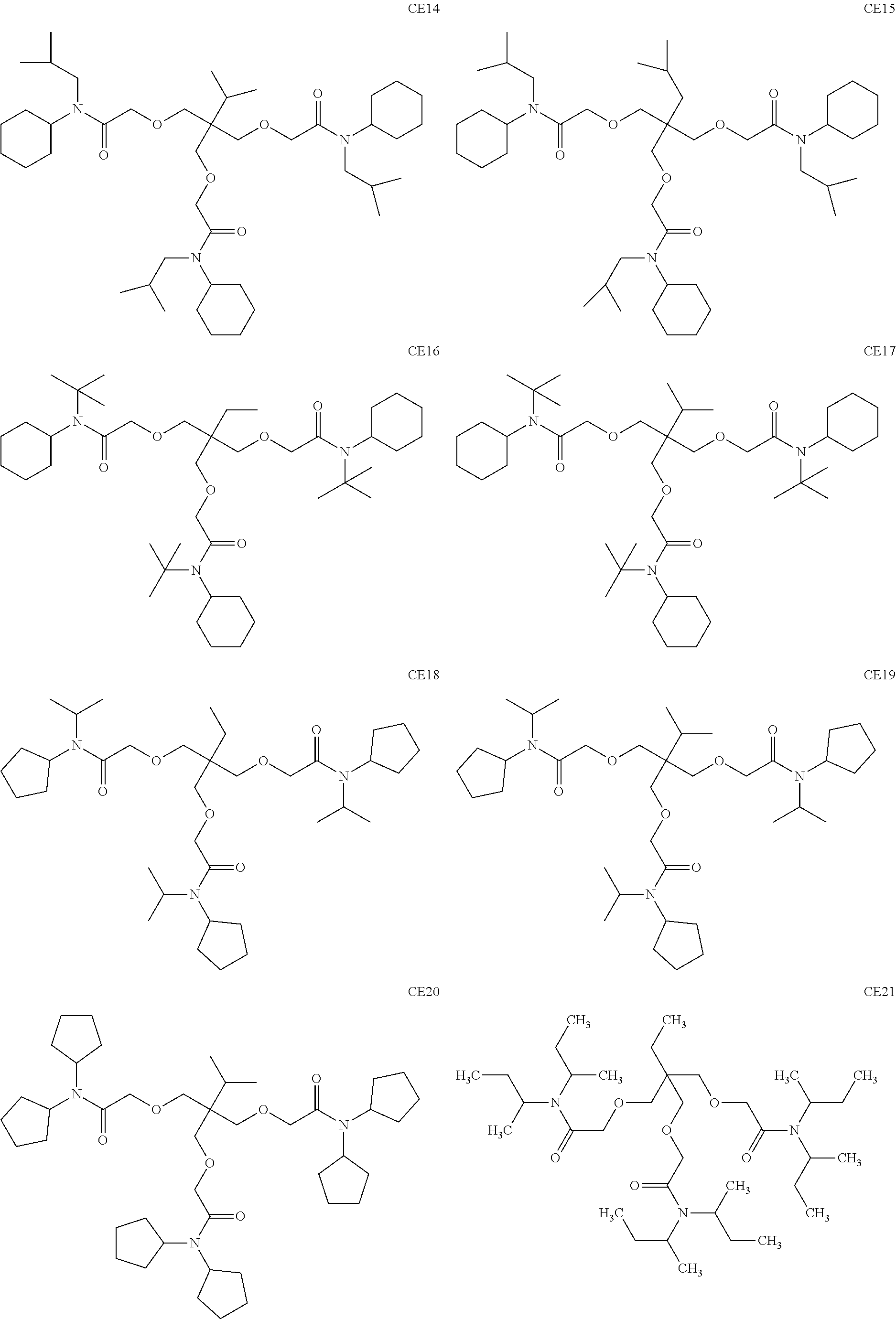

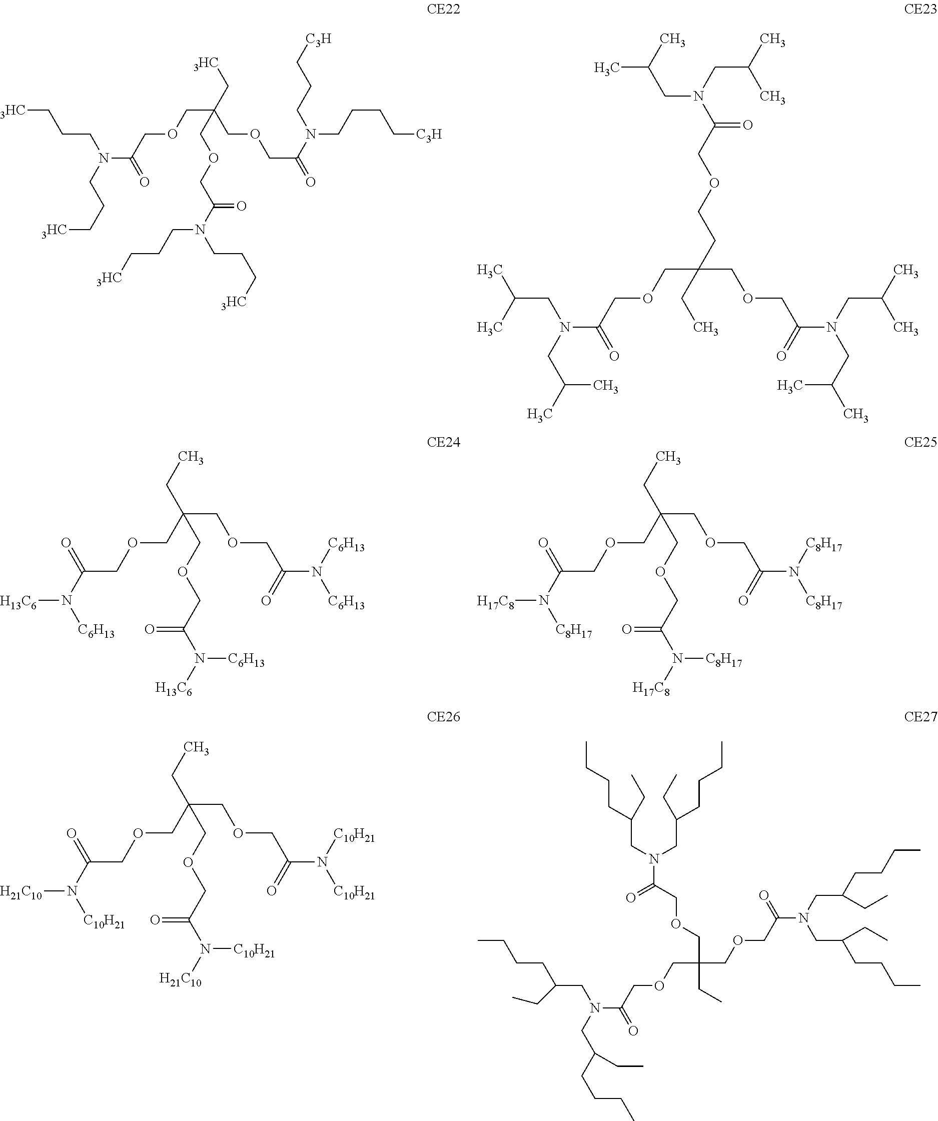

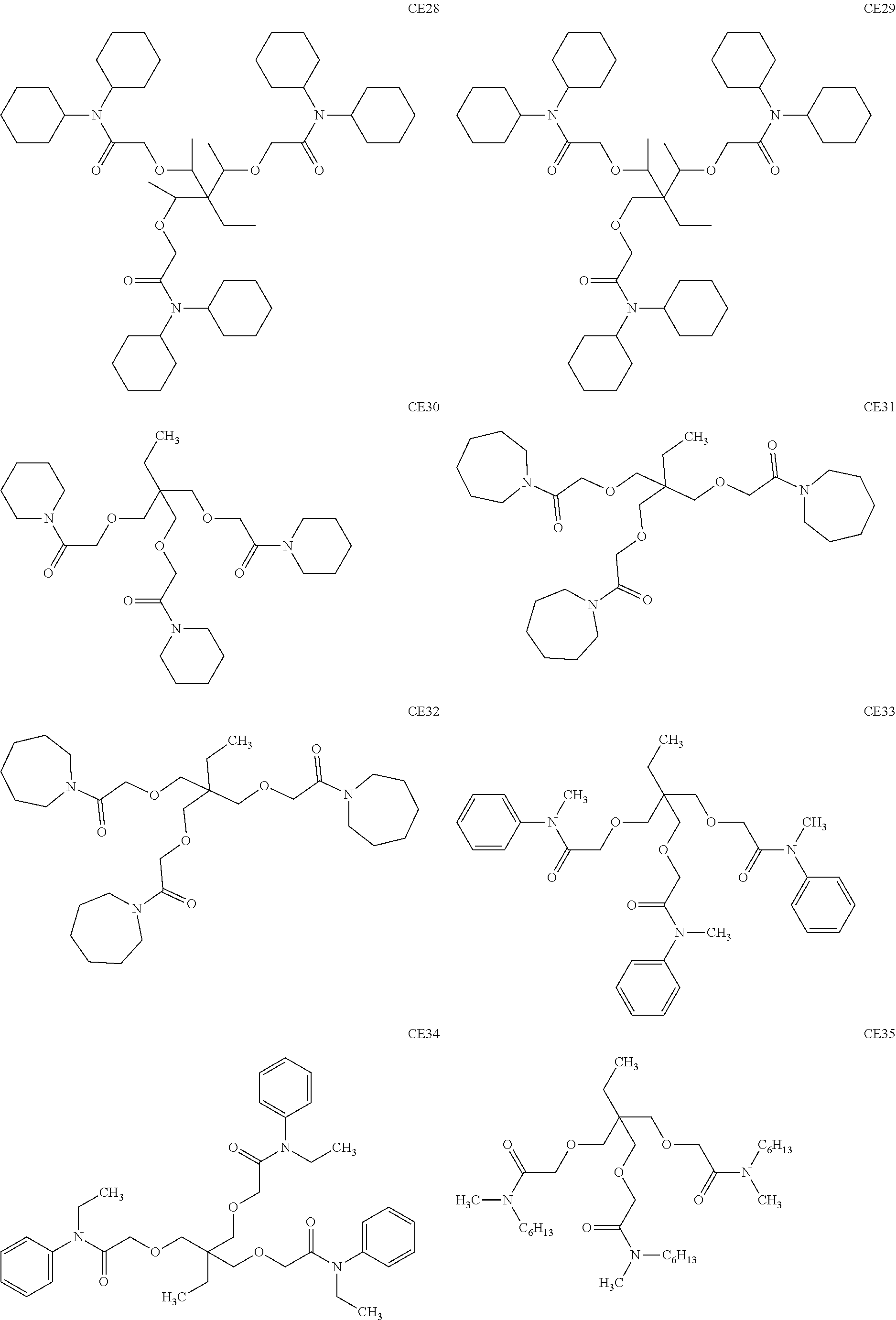

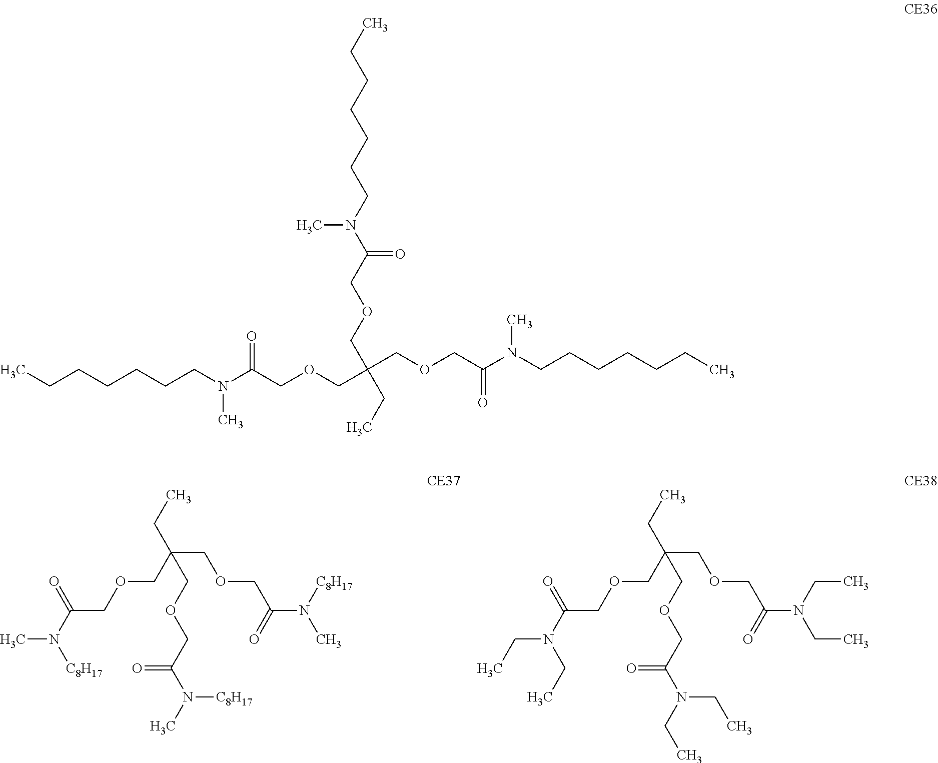

In particular, the second organic compound extracting the cation of the salt to be extracted can be chosen from 4-tert-butyl-Calix[4]arene acid tetraethyl ester, 4-tert-butyl-Calix[6]arene acid hexaethyl ester, 2-[2,2-bis[[2-(dicyclohexylamino)-2-oxoethoxy]methyl]butoxy]-N,N-dicyclohexyl-acetamide and N,N,N′,N′,N″,N″-Hexacyclohexyl-4,4′,4″-propylidynetris(3-oxabutyramide).

The organic phase can also comprise a hydrophobic polar organic diluent. Preferably this is an aromatic diluent which can be chosen from polar aromatic compounds such as 1-chloro-2-bromo-benzene, 1,2-dibromobenzene, 2-bromotoluene or 3,4-dibromotoluene.

The first organic compound solvating the anion of the salt to be extracted can be present in the liquid hydrophobic organic phase at a concentration of at least 0.1 mol/L and the relative molar ratio of the said solvating molecule of the said complementary anionic species to the said extracting molecule of the said cationic species is greater than 1.

The second organic compound extracting the cation of the salt to be extracted can be present in the liquid hydrophobic organic phase at a concentration of at least 0.1 mol/L.

Before recovering the brine from which salt to be extracted has been removed, the said brine can be sent to another extraction stirrer-mixer followed by an extraction decanter-separator, which receives the regenerated organic phase, in order to obtain, after decantation, a brine having even less salt to be extracted, which is recovered or sent again to another extraction stirrer-mixer followed by an extraction decanter-separator in order to obtain a brine having even less salt to be extracted than previously, wherein the said operation of extracting the salt to be extracted from the brine can be repeated at least once, and the organic phase loaded with salt to be extracted is returned from a given decanter-separator to the lower-level stirrer-mixer in order to recover, at the outlet of the initial decanter-separator, the organic phase loaded with salt which is sent to the so-called “organic” heat exchanger.

In particular, the plurality of extraction stirrer(s)-mixer(s)-decanter(s)-separator(s) can operate in countercurrent. The aqueous phase entering an extraction stirrer-mixer is brought into contact with the organic phase coming from an upper extraction decanter-separator.

At least one other regeneration column can be provided, connected in parallel with the initial regeneration column, which is supplied with part of the flow from the so-called “organic” heat exchanger.

In particular, the regeneration column(s) can be stirred column(s) or pulsed column(s).

The water which is to serve as regeneration water can be sent into a so-called “water” heat exchanger in which it is heated by the water loaded with salt to be extracted leaving the regeneration column or the regeneration columns if several are provided, in order to obtain a heated regeneration water which can be heated further before being introduced into the regeneration column or columns, and cooled water loaded with salt to be extracted is obtained from the said heat exchanger.

Before being sent to the initial extraction stirrer-mixer, the washing water loaded with impurities can be sent to a purification unit in order to obtain:
a retentate or concentrate or raffinate brine which is sent to the initial extraction stirrer-mixer; and
a purified water, which is fed back to the initial washing stirrer-mixer.

In particular, before sending the washed organic phase leaving the so-called washing decanter-separator to the so-called “organic” heat exchanger, the said washed organic phase is sent to another so-called washing stirrer-mixer followed by a so-called washing decanter-centrifugal separator which receives washing water, in order to obtain, after decantation, an organic phase which has undergone a further washing step which is sent to the so-called “organic” heat exchanger, it being possible for the said operation of washing the organic phase to be repeated at least once more, and the washing water loaded with impurities, or the retentate or concentrate or raffinate brine, is returned, after purification, to the initial washing stirrer-mixer.

In particular, the plurality of stirrer(s)-mixer(s)-washing decanter(s)-centrifugal separator(s) can operate in countercurrent. The aqueous phase entering a washing stirrer-mixer is brought into contact with the organic phase coming from an upper decanter-centrifugal separator.

The water loaded with salt to be extracted, which comes either from the regeneration column(s) or from the so-called “water” heat exchanger, can be sent to a purification unit in order to obtain:
a water loaded with the concentrated and purified salt to be extracted;
a purified water, which is sent either to the regeneration columns or to the so-called “water” heat exchanger.

The purification unit can be a reverse osmosis unit or a membrane distillation unit or an evaporation/condensation unit or a unit for the absorption of water by a temperature-regenerable organic phase or a combination of at least two of these units.

At least one of:
distilled water;
fresh water;
desalinated water; and
at least some of the water loaded with the concentrated and purified salt to be extracted from the purification unit (2f), possibly after cooling,
   can be used as the washing water.

The initial decanter-separator and/or the washing decanter(s)-separator(s), when present, can be decanters-centrifugal separators, allowing the removal of a phase composed of solid waste or an aqueous washout of the organic phase or the separation of a liquid two-phase medium with an aqueous phase/organic phase ratio of less than 1.0 for the initial decanter-separator and less than 0.2 for the washing decanter(s)-separator(s).

The salt to be extracted selectively can be selected from sodium salts, such as NaCl, NaCN, NaNO₃, NaBr, NaI, potassium salts, such as KCl, KCN, KNO₃, KBr, KI, lithium salts, such as LiCl, LiCN, LiNO₃, LiBr, LiI, or other salts which can be selectively extractable in the presence of other salts.

The salts preferentially extracted are so-called di-ionic salts, i.e. a salt comprising a mono-atomic cation carrying a single positive charge, such as the Li⁺ cation, the K⁺ cation or the Na⁺ cation, and a mono- or poly-atomic anion carrying a single negative charge, such as the mono-atomic anion Cl⁻ or the poly-atomic anion NO₃⁻.

The volume ratio between the washing water and the organic phase introduced into the so-called washing stirrer(s)-mixer(s) can be between 0.01 and 0.1, preferably between 0.03 and 0.06.

The volume ratio between the hot water and the organic phase introduced into the so-called regeneration column(s) can be between 0.05 and 0.2, preferably between 0.08 and 0.15.

The following Examples illustrate the present invention without limiting its scope.

### EXAMPLE 1

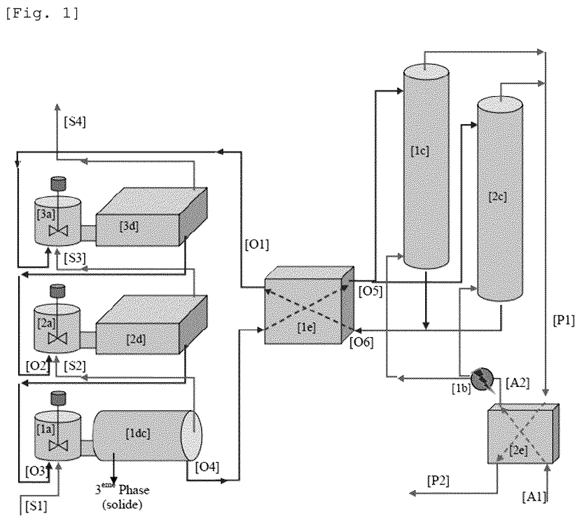

The installation shown in FIG. 1 is designed to treat a salt water or brine effluent S, which contains n dissolved salts, composed of cations and anions, from which the salt to be extracted is at least extractable by a dedicated organic formulation effluent O circulating in a closed loop.

The ionic composition of the salt water or brine S, that of the organic formulation O and that of the aqueous phase A vary throughout the process, receiving the successive notations S1 to S4, O1 to O6 and A1 and A2 respectively.

The desired product is in the form of a hot aqueous phase P1 loaded with at least the salt to be extracted, which, after cooling, is recovered as production effluent P2.

The installation shown in FIG. 1 comprises:
three extraction stirrers-mixers 1a, 2a, 3a; these extraction stirrers-mixers each ensure a thorough mixing of the aqueous and organic phases which are supplied to them;
three decanters-phase separators 1d, 2d and 3d, associated respectively with the extraction stirrers-mixers 1a, 2a, 3a; these decanters-phase separators—the first of which can be of the centrifugal type, in which case it is denoted 1dc—allow the separation of organic and aqueous phases of an effluent after the latter has passed through the respective extraction stirrer-mixer 1a, 2a, 3a;
two heat exchangers 1e, 2e, each allowing the heating and cooling of the organic phase and the aqueous phase, respectively, which are supplied to them, the exchanger 1e being the main exchanger;
two differential contactors 1c, 2c, which are here static or stirred or pulsed columns, each allowing the hot desorption or deextraction of the organic phase supplied to it of at least the salt to be extracted previously absorbed by the organic phase in the extraction stirrers-mixers 1a to 3a;
a heating unit 1b, the role of which is described below.

The salt water or brine to be treated S1 is mixed in the stirred reactor 1a with the organic phase O3 to produce an organic phase dispersed in a continuous aqueous phase (or vice versa). The two-phase mixture is then transferred to the centrifugal decanter 1dc for the separation of the two liquid phases, and the generation of the effluent S2 sent to the stirred reactor 2a and of the effluent O4 sent to the main heat exchanger 1e. It can also allow the removal of an aqueous washout in the organic phase O4 (not shown in FIG. 1) or the removal of a third phase composed of waste, in particular solid waste, before the effluent O4 is sent to the heat exchanger 1e.

The salt water or brine S2 is then mixed in the stirred reactor 2a with the organic phase O2 to produce an organic phase dispersed in a continuous aqueous phase (or vice versa). The two-phase mixture is then transferred to the decanter 2d for the gravity separation of the two liquid phases, and the generation of the effluent S3 sent to the stirred reactor 3a and of the effluent O3 sent to the stirred reactor 1a.

The salt water or brine S3 is then mixed in the stirred reactor 3a with the organic phase O1 to produce an organic phase dispersed in a continuous aqueous phase (or vice versa). The two-phase mixture is then transferred to the decanter 3d for the gravity separation of the two liquid phases, and the generation of the treated effluent S4 (the raffinate) and of the effluent O2 sent to the stirred reactor 2a.

The organic phase O4, loaded with at least the salt to be extracted, is then pumped to the main heat exchanger 1e where it is reheated to obtain the hot effluent O5 loaded with the salt to be extracted and then sent to the top (it is considered here that the density of O5 is greater than the density of P1) of columns 1c and 2c, operating in parallel, for the production at the bottom of these columns of two organic effluents which are then combined to form O6, a hot organic phase without salt, regenerated and pumped to the main heat exchanger 1e to be cooled and then recovered in the form of organic effluent O1.

The aqueous phase A1, generally fresh, desalinated or de-ionised water, is pumped to the secondary heat exchanger 2e where it is heated to obtain the hot effluent A2 which is then sent in bottom injection of columns 1c and 2c, operating in parallel, for the production at the top of the two columns of two aqueous effluents, loaded with at least the salt to be extracted, which are then combined to form production P1, a hot aqueous phase loaded with at least the salt to be extracted and pumped to the secondary heat exchanger 2e to be cooled there and then recovered as production effluent P2.

The heating unit 1b compensates for heat loss caused by the difference in temperature of the effluents at the cold end of the heat exchangers 1e and 2e.

Columns 1c and 2c are preferably used with a continuous descending organic phase and an ascending dispersed aqueous phase, with a high organic phase/aqueous phase (O/A) flowrate ratio in regeneration (hot water desorption), greater than 5, preferably greater than 10, potentially greater than 15 or even greater than 20. This makes it possible to minimise fresh water consumption for desorption of the salt to be extracted while at the same time increasing reconcentration of the salt to be extracted between the water to be treated and the regeneration or desorption water to be produced. An increase in regeneration temperature promotes higher O/A.

The aqueous effluent P1 does not see any transfer of organic phase droplets, just as the top of columns 1c and 2c does not see any gaseous organic headspace due to the installation at the top of these columns, in the aqueous phase, of systems allowing the coalescence of any organic phase associated with an appropriate residence time for the organic matter to settle. It should be noted that this design is also relevant due to the absence of an organic gaseous phase at the top of the column, even if the ratio of O/A flowrates during regeneration is high.

It may also be considered that the aqueous effluents S4, P1 or P2 can be subjected to the removal of organic traces by the installation of an oil-water separation unit which can be a decanter and/or a coalescer combined with an adsorption unit using adsorbents which may be activated carbon, silica gel, diatomite earth and/or another similar approach enabling the organic components to be recycled to the process and/or transported, together with the adsorption media, to a disposal plant by incineration.

This cycle is referred to as 3-0-Z, 3 being the number of unit operations for extracting the salt to be extracted, 0 being the number of washing operations and Z being the number of theoretical stages for regeneration-desorption with hot water.

### EXAMPLE 2

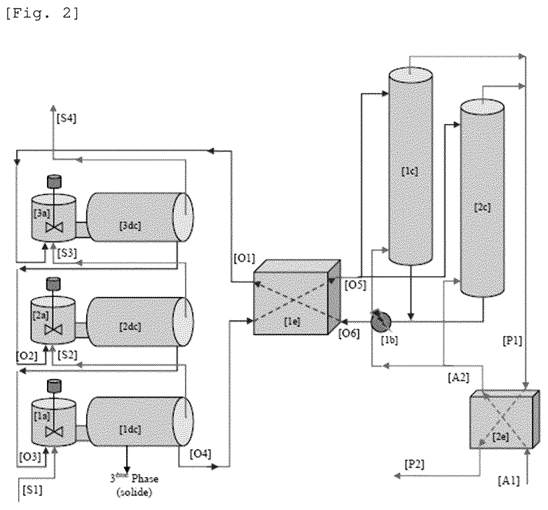

The installation shown in FIG. 2 is identical to that shown in FIG. 1, except that the decanters-separators 2d and 3d have been replaced by centrifugal decanters 2dc and 3dc, and the reheating unit 1b, which is needed to compensate for the heat loss at the cold ends of the exchangers 1e and 2e, has been placed on the organic effluent O6 instead of the aqueous effluent A2.

The salt water or brine S used in this example is difficult to separate by gravity separation and a centrifugal separation is necessary. Also, the economic conditions of the process may favour the use of decanters-centrifugal separators instead of gravity decanters-separators.

### EXAMPLE 3

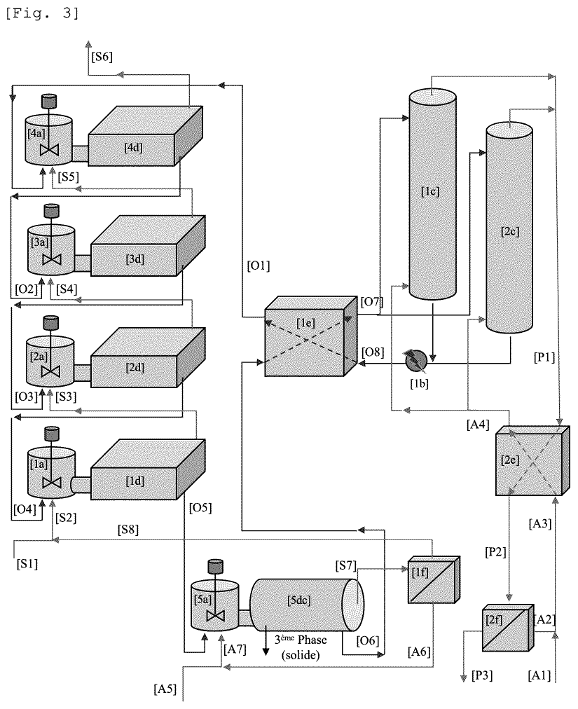

The installation shown in FIG. 3 is designed to treat a salt water or brine effluent S, which contains n dissolved salts, composed of cations and anions, from which the salt to be extracted is at least extractable by a dedicated organic formulation effluent O circulating in a closed loop.

The ionic composition of the salt water or brine S and that of the organic formulation O vary throughout the process, being given the successive notations S1 to S6 and O1 to O8 respectively.

The desired product is in the form of a hot aqueous phase P1 loaded with at least the salt to be extracted, which, after cooling, is recovered as production effluent P2, and after reconcentration, is recovered as production effluent P3.

The installation shown in FIG. 3 comprises:
five stirrers-mixers 1a, 2a, 3a, 4a, 5a; each of these stirrers-mixers ensures a thorough mixing of the aqueous and organic phases which are supplied to them, the stirrers-mixers 1a, 2a, 3a and 4a being extraction stirrers-mixers and the stirrer-mixer 5a being a washing stirrer-mixer;
five decanters-phase separators 1d, 2d, 3d, 4d and 5dc, associated respectively with the stirrers-mixers 1a, 2a, 3a, 4a and 5a, these decanters-phase separators—the last of which may be of the centrifugal type, being denoted 5dc—allowing the separation of the organic and aqueous phases of an effluent after the latter has passed through the respective stirrer-mixer 1a, 2a, 3a, 4a and 5a;
two heat exchangers 1e, 2e, allowing each the heating and cooling of the organic phase and of the aqueous phase, respectively, which are supplied to them, the exchanger 1e being the main exchanger;
two differential contactors 1c, 2c which are here static or stirred or pulsed columns, each allowing the hot desorption or deextraction of the organic phase supplied to it of at least the salt to be extracted, previously absorbed by the organic phase in the stirrers-mixers 1a to 4a;
a heating unit 1b, the role of which described below;
two units for reverse osmosis and/or membrane distillation and/or evaporation/condensation and/or absorption of water by a temperature-regenerable organic phase 1f, 2f allowing the separation of a retentate or concentrate or raffinate and of a permeate or condensate or de-extract.

The salt water or brine to be treated S1 and the aqueous retentate/concentrate/raffinate S8 are mixed in the stirred reactor 1a with the organic phase O4 to produce a dispersed organic phase in a continuous aqueous phase (or vice versa). The two-phase mixture is then transferred to the decanter 1d for the separation of the two liquid phases, and the generation of the effluent S3 sent to the stirred reactor 2a and of the effluent O5 sent to the stirred reactor 5a.

The salt water or brine S3 is then mixed in the stirred reactor 2a with the organic phase O3 to produce an organic phase dispersed in a continuous aqueous phase (or vice versa). The two-phase mixture is then transferred to the decanter 2d for the separation of the two liquid phases, and the generation of the effluent S4 sent to the stirred reactor 3a and of the effluent O4 sent to the stirred reactor 1a.

The salt water or brine S4 is then mixed in the stirred reactor 3a with the organic phase O2 to produce an organic phase dispersed in a continuous aqueous phase (or vice versa). The two-phase mixture is then transferred to the decanter 3d for the separation of the two liquid phases, and the generation of the effluent S5 sent to the stirred reactor 4a and of the effluent O3 sent to the stirred reactor 2a.

The salt water or brine S5 is then mixed in the stirred reactor 4a with the organic phase O1 to produce an organic phase dispersed in a continuous aqueous phase (or vice versa). The two-phase mixture is then transferred to the decanter 4d for the separation of the two liquid phases, and the generation of the treated effluent S6 (the raffinate) and of the effluent O2 sent to stirred reactor 3a.

The organic phase O5, loaded with at least the salt to be extracted, is then mixed in the stirred reactor 5a with the aqueous phase A7 to produce an aqueous phase dispersed in a continuous organic phase (or vice versa). The two-phase mixture is then transferred to the centrifugal decanter 5dc for the separation of the two liquid phases, and the generation of the effluent S7 sent to a water recovery unit 1f such as a reverse osmosis unit, a membrane distillation unit and/or an evaporation/condensation unit and/or a unit for absorption of water by a temperature-regenerable organic phase, and of the effluent O6 sent to the main heat exchanger 1e. The purpose of this step is to wash the organic phase O5 with a very small flow of water A7 to remove salt impurities in order to improve the purity of the salt to be extracted contained in the organic effluent O6. The centrifugal decanter 5dc can also be used to remove aqueous washout in the organic phase O5 while removing an organic washout in the aqueous phase S7, or to remove a third phase consisting of solid waste or other matter, before the effluent O6 is sent to the heat exchanger 1e and before the effluent S7 is sent to the water recovery unit 1f.

The aqueous phase A7, generally composed of the aqueous phase A5 which is distilled water, fresh water or desalinated water and recycle water A6 is used as a minor flowrate compared to the organic flow, with a flowrate ratio A/O for the water washing (washing with cold water, of neutral pH, the pH having no impact on the washing performance), of less than 0.25, preferably less than 0.1, potentially less than 0.05, or as low as 0.01. This makes it possible both to minimize the consumption of fresh water for the washing while increasing the purity of salt to be extracted from the production P1 while minimizing the loss of salt to be extracted by washing and/or the loss of overall extraction yield of the salt to be extracted.

The aqueous phase S7 pumped to a reverse osmosis unit and/or a membrane distillation unit and/or an evaporation/condensation unit and/or a water absorption unit by a temperature-regenerable organic phase if is then separated into a brine S8 (retentate or concentrate or raffinate) sent to the stirred reactor 1a and an aqueous effluent A6 (permeate or condensate or de-extract) recycled to the inlet of the stirred reactor 5a.

The organic phase O6, loaded with salt to be extracted, is then pumped to the main heat exchanger 1e where it is heated to obtain the hot organic effluent O7 loaded with salt to be extracted and then sent to the head of the columns 1c and 2c, operating in parallel, for the production at the bottom of the columns of two organic effluents which are then combined to form the effluent O8, a salt-free hot organic phase, regenerated and pumped to the main heat exchanger 1e to be cooled and then recovered in the form of a cold organic effluent O1 (it is assumed here that the density of O7 is greater than the density of P1).

The aqueous phase A1, generally fresh water, desalinated or de-ionised water, which may be combined with the permeate-condensate-de-extract A2 from a water recovery unit 2f, a reverse osmosis unit, a membrane distillation unit and/or an evaporation/condensation unit and/or a unit for absorbing water by a temperature-regenerable organic phase, is pumped as aqueous effluent A3 to the secondary heat exchanger 2e, where it is heated to obtain the hot aqueous effluent A4, which is then sent in bottom injection of the columns 1c and 2c, operating in parallel, to produce at the top of the two columns two aqueous effluents, loaded with at least the salt to be extracted, which are then combined to form the production P1, a hot aqueous phase loaded with at least the salt to be extracted and pumped to the secondary heat exchanger 2e to be cooled there and then recovered as the production effluent P2, which can be reconcentrated via the water recovery unit 2f, a reverse osmosis unit, a membrane distillation unit and/or an evaporation/condensation unit and/or a unit for the absorption of water by a temperature-regenerable organic phase, to produce a permeate-condensate-de-extract A2 and a concentrated production effluent P3.

The heating unit 1b compensates for heat loss caused by the difference in temperature of the effluents at the cold end of the heat exchangers 1e and 2e.

The columns 1c and 2c are preferably used with a continuous descending organic phase and an ascending dispersed aqueous phase, with a high O/A flowrate ratio in regeneration (hot water desorption), greater than 5, preferably greater than 10, potentially greater than 15 or even greater than 20. This makes it possible to minimize fresh water consumption for desorption of the salt to be extracted while at the same time increasing reconcentration of the salt to be extracted between the water to be treated and the regeneration or desorption water to be produced. The higher the regeneration temperature of the organic phase in 1c and 2c, the higher the O/A ratio.

The aqueous effluent P1 does not see any transfer of organic phase droplets, just as the top of the columns 1c and 2c does not see any gaseous organic sky due to the installation at the top of these columns, in the aqueous phase, of systems allowing the coalescence of any organic phase associated with an appropriate residence time for the organic matter to settle. It should be noted that this design is also relevant due to the absence of an organic gaseous phase at the top of the column, even if the flowrate ratio O/A during regeneration is high.

The equipment 5a and 5dc can be combined to form a single piece of equipment commonly known as a centrifugal extractor. This equipment can be doubled, tripled or quadrupled by series connection, preferably in countercurrent, to improve the washing of the O5 in order to generate as effluent P1, a product of greater purity of the salt to be extracted. This equipment can be multiplied and used in parallel in order to be able to treat O5 effluents with increasing flowrates.

It may also be considered that the aqueous effluents S6, S7, P1, P2 or P3 can be subjected to the removal of organic traces by the installation of an oil-water separation unit which may be a decanter and/or a coalescer combined with an adsorption unit using adsorbents which may be activated carbon, silica gel, diatomaceous earth and/or another similar approach enabling the organic components to be recycled to the process and/or transported, together with the adsorption media, to a disposal facility by incineration.

All the effluents to the left of heat exchanger 1e and below heat exchanger 2e are preferably operated close to ambient temperature (5 to 35° C.) when the other effluents (top right of FIG. 3) operate at higher temperatures but below the boiling point of the water and brine effluents A4 and P1 for the operating pressures of 1c, 2c and 2e.

An alternative to this configuration may be implemented when the saline or brine aqueous phase to be treated, due to its intrinsic properties of density, viscosity and/or others, does not allow sufficient gravity settling to be economically viable. In this case, instead of the extraction mixers-gravity decanters 1d, 2d, 3d and 4d, mixers-centrifugal decanters 1dc, 2dc, 3dc and 4dc are preferentially used or, potentially, centrifugal extractors with an increased internal mixing time compared with the current state of the art.

This cycle is referred to as 4-1-Z, 4 being the number of unit operations for extracting the salt to be extracted, 1 being the number of washing operations and Z being the number of theoretical stages for regeneration-desorption of the organic phase using hot water.

### EXAMPLE 4

When treating salt water or brine with a low relative concentration of the salt to be extracted compared with the other salts present, it may be necessary to use several cold washing/scrubbing stages in series in order to improve the washing and the removal of impurities from the organic phase.

The installation shown in FIG. 4 is therefore identical to that shown in FIG. 3, with the addition of two further stirrers-mixers 6a and 7a, together with decanter-centrifugal separators 6dc and 7dc.

The organic phase O5, loaded with the salt to be extracted, is then mixed in the stirred reactor 7a with the brine S10 to produce an aqueous phase dispersed in a continuous organic phase (or vice versa). The two-phase mixture is then transferred to the centrifugal decanter 7dc for the separation of the two liquid phases, and the generation of effluent S7 sent to a water recovery unit 1f such as a reverse osmosis unit, a membrane distillation unit and/or an evaporation/condensation unit and/or a unit for absorption of water by a temperature-regenerable organic phase, and of effluent O6 sent to the stirrer-mixer 6a.

The aqueous phase S7 pumped to a reverse osmosis unit, a membrane distillation unit and/or an evaporation/condensation unit and/or a water absorption unit by a temperature-regenerable organic phase if is then separated into a brine S8 (retentate or concentrate or raffinate) sent to the stirred reactor 1a and an aqueous effluent A6 (permeate or condensate or de-extract) recycled to the inlet of the stirred reactor 5a.

The organic phase O6, loaded with the salt to be extracted, is then mixed in the stirred reactor 6a to produce an aqueous phase dispersed in a continuous organic phase (or vice versa). The two-phase mixture is then transferred to the centrifugal decanter 6dc for separation of the two liquid phases, and the generation of effluent S10 sent to the stirred reactor 7a and of effluent O7 sent to the stirrer-mixer 5a.

The organic phase O7, loaded with the salt to be extracted, is then mixed in the stirred reactor 5a to produce an aqueous phase dispersed in a continuous organic phase (or vice versa). The two-phase mixture is then transferred to the centrifugal decanter 5dc for the separation of the two liquid phases, and the generation of effluent S9 sent to the stirred reactor 6a and of effluent O8 sent to the heat exchanger 1e.

The addition of one, two or three stirrers-mixers for the cold washing of the organic phase improves the purity and selectivity of the salt to be extracted.

This cycle is referred to as 4-3-Z, 4 being the number of unit operations for extracting the salt to be extracted, 3 being the number of washing operations and Z being the number of theoretical stages for regeneration-desorption of the organic phase using hot water.

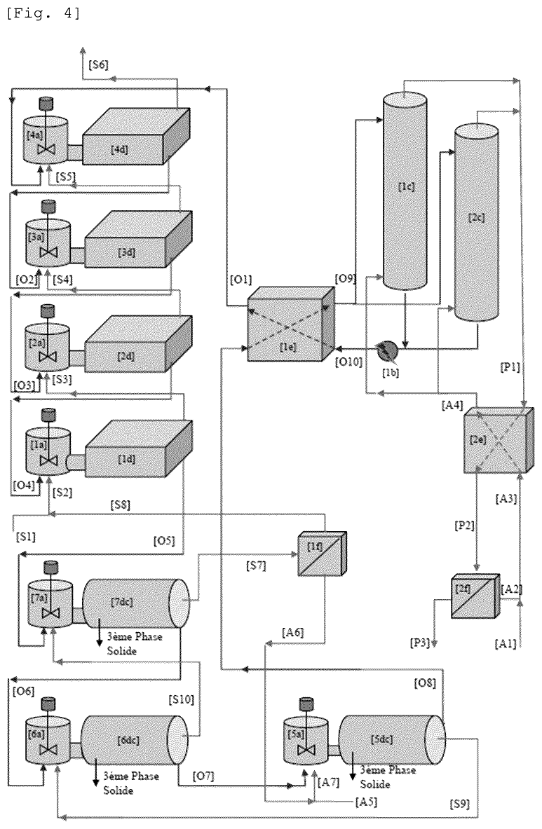

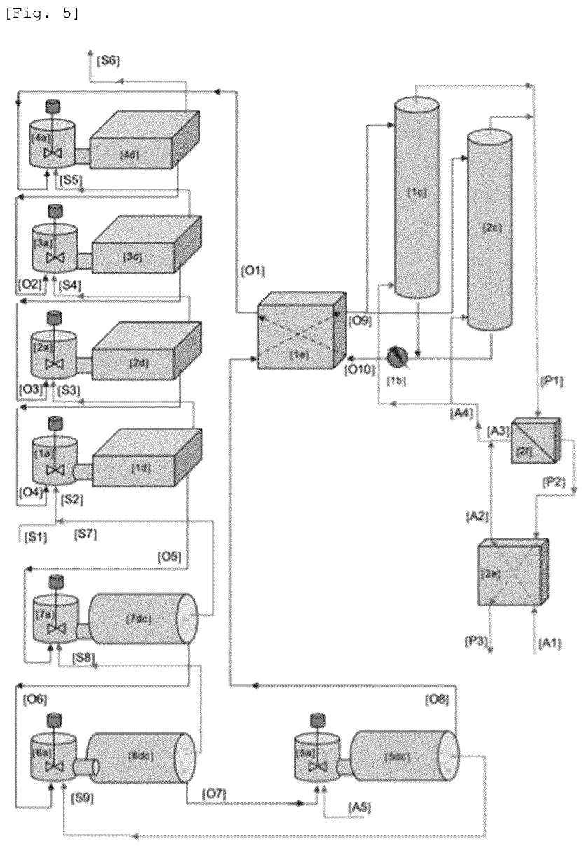

The installation in FIG. 5 is identical to that in FIG. 4, with the water recovery unit 2f moved from the cold zone to the hot zone of the secondary “water” heat exchanger 2e and the water recovery unit 1f removed.

The water recovery unit 2f can then be a membrane distillation unit and/or an evaporation/condensation unit and/or a unit for absorbing water using a temperature-regenerable organic phase.

### EXAMPLE 5

In this example, the salt to be selectively extracted is sodium chloride NaCl.

The organic phase O comprises
as an extractant for the Na⁺ ion, the sodium ionophore X, also known as 4-tert-butyl-Calix[4]arene acid tetraethyl ester (C₆₀H₈₀O₁₂, CAS no: 97600-39-0) at a concentration of 0.275 M (mol/L) and for which the log K for the Na⁺ ion in methanol at 25° C. is 5;
as an anionic solvating agent, N-(3,5-dichlorophenyl)-octanamide (C₁₄H₁₉Cl₂NO, CAS No: 20398-46-3) at a concentration of 0.825 M and with a pKa in water of 13.83+/−0.70; and
1-chloro-2-bromo-benzene as a diluent.

The organic phase has a density of 1.48 g/L at 20° C.

The brine to be treated includes sodium chloride to be extracted as well as potassium chloride. The brine has a salinity of 209.81 g/L, including 2.26 g/L of Na⁺ and 107 g/L of K⁺.

By contacting this brine at room temperature (20° C.) with volume ratios of the organic phase as used in relation to the aqueous brine (O/A)_{extraction} of 0.05, 0.2, 0.5, 1 and 4 respectively, a high relative extraction of sodium, in the form of NaCl, in relation to potassium, or KCl, was obtained, as shown in the graph in FIG. 6.

This sodium extraction is selective without modifying the potassium concentration, as shown in FIG. 7. The potassium concentration remains stable at around 107 g/L for tests with (O/A)_{extraction} ratios of 0.05, 0.2, 0.5 and 1, and a residual sodium concentration of 168 mg/L in the brine treated with a (O/A)_{extraction} ratio of 1.

FIG. 8 shows the ionic concentrations of the various compounds in the organic phase after extraction. NaCl is majority in the organic phase for a (O/A)_{extraction} ratio of less than 2 and even more so when the (O/A)_{extraction} ratio is low.

Then, in order to demonstrate the very poor holding of KCl within the organic phase, the formulation loaded with Na, K and Cl was considered after extraction at a (O/A)_{extraction} ratio of 0.5 and after a water washing was carried out at room temperature (20° C.), with very small quantities of water ranging from 1% to 20% of the volume of the organic phase, also noted as the (A/O)_{washing} ratio.

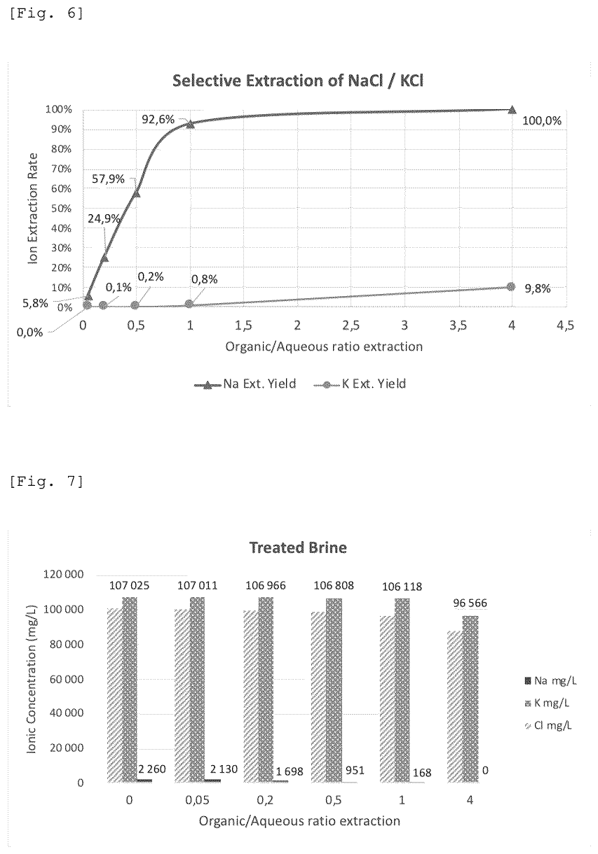

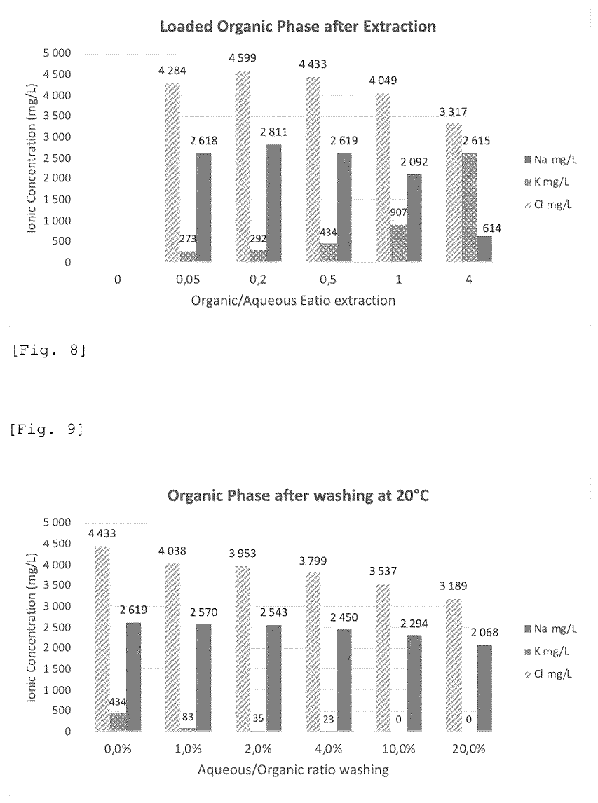

The results as obtained are shown in FIG. 9. It appears that as soon as the organic phase is brought into contact with 1% volume of water, 80.8% of the KCl absorbed in the organic phase returns to the water, compared with only 1.9% of the NaCl. It also appears that with 4% volume of water, in one washing step, 94.8% of the KCl is desorbed/transferred to the water compared with 6.4% of the NaCl.

It can also be seen that NaCl is difficult to desorb at room temperature, with only 21.1% of NaCl transferred to water when the volume of water is 20% of the organic phase.

In order to allow the NaCl to pass into the aqueous phase and to regenerate the organic phase, a hot regeneration is used, at 80° C., of the formulation resulting from the washing with 4% of the volume of water, by bringing into contact a volume of hot water of 2%, 5%, 10%, 20% and 50% of the volume of the organic phase, this ratio being noted (A/O)_{regeneration}.

The results as obtained are shown in FIG. 10. It appears that with 20% water by volume, 67.3% of the NaCl was desorbed from the organic phase at 80° C. (compared with 21.1% previously at 20° C.).

FIG. 11 shows the ionic concentrations of the brine which is obtained after regeneration at 80° C. After a washing stage with a (A/O)_{washing} ratio of 4%, the brine obtained from the hot regeneration for these various (A/O)_{regeneration} ratios consists of 93% to 99% NaCl by mass, which enables a purification of NaCl associated with a minimal NaCl loss.

A parametric study was carried out on cycles 4-1-3 (cycle of Example 3 with three theoretical stages for regeneration-desorption with hot water) and 4-2-3 (cycle with two cold water washing operations and three theoretical stages for regeneration-desorption with hot water).

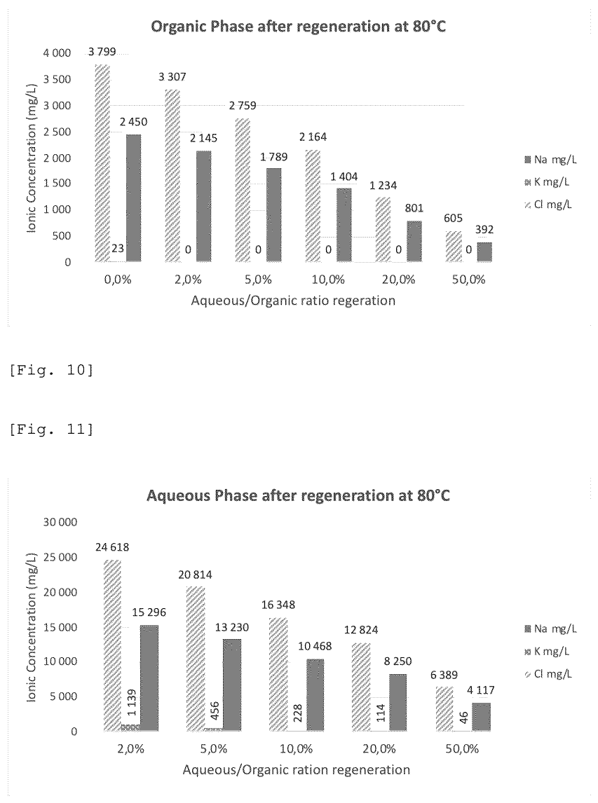

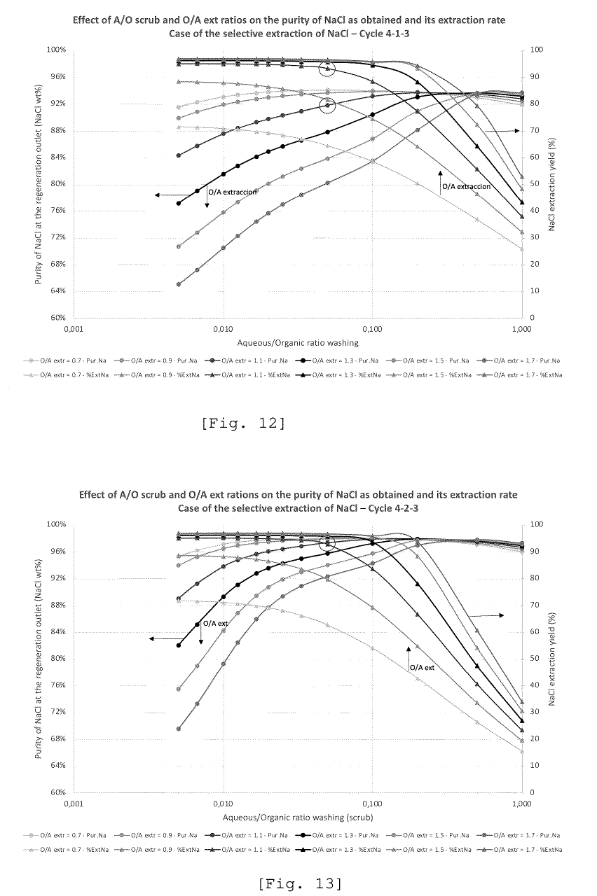

The results of cycle 4-1-3 are shown in FIG. 12.

By extending the curves to the left, i.e. at a (A/O)_{washing} ratio tending towards 0, we would have the performance of a cycle without washing with water 4-0-3. It is clear here that this washing, carried out by increasing the (A/O)_{washing} ratio, makes it possible to increase the purity of the NaCl produced at the outlet of the regeneration columns to a high level of around 94% NaCl by mass (excluding water). In addition, for sufficiently high (O/A)_{extraction} ratios, the NaCl extraction rate at 20° C. can be maintained at over 90% while increasing the purity of the NaCl de-extracted by washing with water at room temperature (20° C. here). For this cycle 4-1-3, the selected sizing point gives a NaCl extraction yield of 93.2% for a NaCl purity of 91.8% by mass, with a (O/A)_{extraction} ratio of 1.1 and a (A/O)_{washing} ratio of 5% (circled points).

FIG. 13 shows the effect of adding a second countercurrent scrubbing stage at room temperature. The addition of a second scrubbing stage at room temperature, by switching from cycle 4-1-3 to cycle 4-2-3, makes it possible to further improve the performance of the process in order to obtain both a high sodium extraction yield and an even higher purity of the NaCl produced (high level at 98% NaCl by mass) at the outlet of the regeneration stage (strip).

For this 4-2-3 cycle, the selected sizing point gives a NaCl extraction yield of 92.8% for a NaCl purity of 97.4% by mass, with a (O/A)_{extraction} ratio of 1.1 and a (A/O)_{washing} ratio of 5% (circled points at the intersection of the two curves).

Table 1 shows the material balance for a cycle 4-1-3 with a (O/A)_{extraction} ratio of 1.1, a (A/O)_{washing} ratio of 5% and a (A/O)_{regeneration} ratio of 10%.

TABLE 1

| | Cycle | | | | | | | |
|---|---|---|---|---|---|---|---|---|
| | S1 | S2 | S6 | A7 | S7 | A3 | P2 | S8 |
| | 4-1-3 | | | | | | | |
| | | Feed Brine | | Scrub | Scrub | Strip | Strip | Concentrate |
| | Feed Brine | in TSSA | Raffinate | Inlet | Outlet | Inlet | outlet | 1f |
| Qv (m3/h) | 1124.4 | 1130.9 | 1127.4 | 55.1 | 55.3 | 110.1 | 111.5 | 6.5 |
| TDS (mg/L) | 312 213 | 312 314 | 305 239 | 0 | 39 074 | 0 | 61 981 | 329 744 |
| Liquid Density(kg/L) | 1.202 | 1.202 | 1.197 | 0.999 | 1.034 | 0.999 | 1.048 | 1.212 |
| Liquid Composition, mg/kg water | | | | | | | | |
| Na+ | 2 678 | 3 024 | 181 | 0 | 6 610 | 0 | 22 696 | 62 952 |
| K+ | 179 972 | 179 582 | 178 643 | 0 | 11 777 | 0 | 2 701 | 112 158 |
| SO4−− | 4 076 | 4 053 | 4 052 | 0 | 7 | 0 | 0 | 68 |
| Cl− | 164 314 | 164 512 | 159 275 | 0 | 20 867 | 0 | 37 448 | 198 730 |
| NaCl (g/kg water) | 6.8 | 7.7 | 0.5 | 0.0 | 16.8 | 0.0 | 57.7 | 160.0 |
| KCl (g/kg water) | 336.8 | 336.1 | 334.3 | 0.0 | 22.4 | 0.0 | 5.1 | 213.8 |
| K2SO4 (g/kg water) | 7.4 | 7.4 | 7.4 | 0.0 | 0.0 | 0.0 | 0.0 | 0.1 |
| Liquid Composition, % weight (excluded water) | | | | | | | | |
| Na+ | 0.20% | 0.22% | 0.01% | 0.00% | 0.64% | 0.00% | 2.14% | 4.58% |
| K+ | 13.32% | 13.29% | 13.31% | 0.00% | 1.13% | 0.00% | 0.25% | 8.16% |
| SO4−− | 0.30% | 0.30% | 0.30% | 0.00% | 0.00% | 0.00% | 0.00% | 0.00% |
| Cl− | 12.16% | 12.18% | 11.87% | 0.00% | 2.01% | 0.00% | 3.52% | 14.46% |
| H2O | 74.02% | 74.01% | 74.51% | 100.00% | 96.22% | 100.00% | 94.09% | 72.79% |
| Liquid Composition, % weight (excluded water) | | | | | | | | |
| NaC | 1.94% | 2.19% | 0.13% | 0.00% | 42.80% | 0.00% | 91.81% | 42.80% |
| KCl | 95.95% | 95.72% | 97.72% | 0.00% | 57.17% | 0.00% | 8.19% | 57.17% |
| K2SO4 | 2.11% | 2.09% | 2.15% | 0.00% | 0.00% | 0.00% | 0.00% | 0.03% |
| Liquid Composition, mg/L solution | | | | | | | | |
| Na+ | 2 382 | 2 690 | 161 | 0 | 6 579 | 0 | 22 383 | 55 516 |
| K+ | 160 066 | 159 712 | 159 371 | 0 | 11 721 | 0 | 2 664 | 98 911 |
| SO4−− | 3 625 | 3 604 | 3 615 | 0 | 7 | 0 | 0 | 60 |
| Cl− | 146 140 | 146 308 | 142 092 | 0 | 20 768 | 0 | 36 933 | 175 257 |
| H2O | 889 394 | 889 350 | 892 119 | 999 000 | 995 257 | 999 000 | 986 250 | 881 887 |
| Ionic Flows, kg/h | | | | | | | | |
| Na+ | 2 678 | 3 042 | 182 | 0 | 364 | 0 | 2 497 | 364 |
| K+ | 179 972 | 180 620 | 179 675 | 0 | 648 | 0 | 297 | 648 |
| SO4−− | 4 076 | 4 076 | 4 076 | 0 | 0 | 0 | 0 | 0 |
| Cl− | 164 314 | 165 462 | 160 195 | 0 | 1 148 | 0 | 4 119 | 1 148 |
| H2O | 1 000 000 | 1 005 775 | 1 005 775 | 55 000 | 55 000 | 110 000 | 110 000 | 5 775 |

| | Cycle | | | | |
|---|---|---|---|---|---|
| | A6 | P3 | A2 | A1 | A5 |
| | 4-1-3 | | | | |
| | Condensate | Concentrate | Condensate | Water to | Water to |
| | 1f | 2f | 2f | strip | scrub |
| Qv (m3/h) | 49.3 | 21.7 | 90.8 | 19.3 | 5.8 |
| TDS (mg/L) | 0 | 318 182 | 0 | 0 | 0 |
| Liquid Density(kg/L) | 0.999 | 1.204 | 0.999 | 0.999 | 0.999 |
| Liquid Composition, mg/kg water | | | | | |
| Na+ | 0.0 | 129 689 | 0.0 | 0.0 | 0 |
| K+ | 0.0 | 15 434 | 0.0 | 0.0 | 0 |
| SO4−− | 0.0 | 0 | 0.0 | 0.0 | 0 |
| Cl− | 0.0 | 213 990 | 0.0 | 0.0 | 0 |
| NaCl (g/kg water) | 0.0 | 329.7 | 0.0 | 0.0 | 0.0 |
| KCl (g/kg water) | 0.0 | 29.4 | 0.0 | 0.0 | 0.0 |
| K2SO4 (g/kg water) | 0.0 | 0.0 | 0.0 | 0.0 | 0.0 |
| Liquid Composition, % weight (excluded water) | | | | | |
| Na+ | 0.00% | 9.54% | 0.00% | 0.00% | 0.00% |
| K+ | 0.00% | 1.14% | 0.00% | 0.00% | 0.00% |
| SO4−− | 0.00% | 0.00% | 0.00% | 0.00% | 0.00% |
| Cl− | 0.00% | 15.74% | 0.00% | 0.00% | 0.00% |
| H2O | 100.00% | 73.58% | 100.00% | 100.00% | 100.00% |
| Liquid Composition, % weight (excluded water) | | | | | |
| NaC | 0.00% | 91.81% | 0.00% | 0.00% | 0.00% |
| KCl | 0.00% | 8.19% | 0.00% | 0.00% | 0.00% |
| K2SO4 | 0.00% | 0.00% | 0.00% | 0.00% | 0.00% |
| Liquid Composition, mg/L solution | | | | | |
| Na+ | 0 | 114 907 | 0 | 0 | 0 |
| K+ | 0 | 13 674 | 0 | 0 | 0 |
| SO4−− | 0 | 0 | 0 | 0 | 0 |
| Cl− | 0 | 189 600 | 0 | 0 | 0 |
| H2O | 999 000 | 886 023 | 999 000 | 999 000 | 999 000 |
| Ionic Flows, kg/h | | | | | |
| Na+ | 0 | 2 497 | 0 | 0 | 0 |
| K+ | 0 | 297 | 0 | 0 | 0 |
| SO4−− | 0 | 0 | 0 | 0 | 0 |
| Cl− | 0 | 4 119 | 0 | 0 | 0 |
| H2O | 49 225 | 19 250 | 90 750 | 19 250 | 5 775 |

This table shows that the raffinate S6 now contains only 0.13% by mass of NaCl to obtain a purity of 99.87% by mass (excluding water) of KCl and K₂SO₄, the quantity of K⁺ ions in this being practically unchanged compared with the quantity present in the brine to be treated S1.

Table 2 shows the material balance for a cycle 4-2-3 with a (O/A)_{extraction} ratio of 1.1, a (A/O)_{washing} ratio of 5% and a (A/O)_{regeneration} ratio of 10%.

TABLE 2

| | Cycle | | | | | | | |
|---|---|---|---|---|---|---|---|---|
| | S1 | S2 | S6 | A7 | S7 | A3 | P2 | S8 |
| | 4-2-3 | | | | | | | |
| | Feed | Feed Brine | | Scrub | Scrub | Strip | Strip | Concentrate\| |
| | Brine | in TSSA | Raffinate | Inlet | Outlet | Inlet | outlet | 1f |
| Qv (m3/h) | 1124.4 | 1132.8 | 1129.2 | 55.1 | 55.5 | 110.1 | 111.4 | 8.4 |
| TDS (mg/L) | 312 213 | 312 347 | 305 129 | 0 | 50 107 | 0 | 58 265 | 330 234 |
| Liquid Density(kg/L) | 1.202 | 1.202 | 1.197 | 0.999 | 1.041 | 0.999 | 1.046 | 1.212 |
| Liquid Composition, mg/kg water | | | | | | | | |
| Na+ | 2 678 | 3 139 | 192 | 0 | 8 807 | 0 | 22 589 | 65 233 |
| K+ | 179 972 | 179 452 | 178 556 | 0 | 14 776 | 0 | 822 | 109 455 |
| SO4−− | 4 076 | 4 046 | 4 046 | 0 | 7 | 0 | 0 | 53 |
| Cl− | 164 314 | 164 576 | 159 218 | 0 | 26 974 | 0 | 35 580 | 199 809 |
| NaCl (g/kg water) | 6.8 | 8.0 | 0.5 | 0.0 | 22.4 | 0.0 | 57.4 | 165.8 |
| KCl (g/kg water) | 336.8 | 335.9 | 334.2 | 0.0 | 28.2 | 0.0 | 1.6 | 208.6 |
| K2SO4 (g/kg water) | 7.4 | 7.3 | 7.3 | 0.0 | 0.0 | 0.0 | 0.0 | 0.1 |
| Liquid Composition, % weight (excluded water) | | | | | | | | |
| Na+ | 0.20% | 0.23% | 0.01% | 0.00% | 0.84% | 0.00% | 2.13% | 4.75% |
| K+ | 13.32% | 13.28% | 13.31% | 0.00% | 1.41% | 0.00% | 0.08% | 7.96% |
| SO4−− | 0.30% | 0.30% | 0.30% | 0.00% | 0.00% | 0.00% | 0.00% | 0.00% |
| Cl− | 12.16% | 12.18% | 11.86% | 0.00% | 2.57% | 0.00% | 3.36% | 14.54% |
| H2O | 74.02% | 74.01% | 74.52% | 100.00% | 95.19% | 100.00% | 94.43% | 72.75% |
| Liquid Composition, % weight (excluded water) | | | | | | | | |
| NaCl | 1.94% | 2.27% | 0.14% | 0.00% | 44.27% | 0.00% | 97.34% | 44.27% |
| KCl | 95.95% | 95.64% | 97.71% | 0.00% | 55.70% | 0.00% | 2.66% | 55.70% |
| K2SO4 | 2.11% | 2.09% | 2.15% | 0.00% | 0.00% | 0.00% | 0.00% | 0.03% |
| Liquid Composition, mg/L solution | | | | | | | | |
| Na+ | 2 382 | 2 792 | 171 | 0 | 8 727 | 0 | 22 311 | 57 515 |
| K+ | 160 066 | 159 593 | 159 300 | 0 | 14 643 | 0 | 812 | 96 505 |
| SO4−− | 3 625 | 3 598 | 3 609 | 0 | 7 | 0 | 0 | 47 |
| Cl− | 146 140 | 146 363 | 142 048 | 0 | 26 730 | 0 | 35 142 | 176 168 |
| H2O | 889 394 | 889 336 | 892 161 | 999 000 | 990 952 | 999 000 | 987 696 | 881 683 |
| Ionic Flows, kg/h | | | | | | | | |
| Na+ | 2 678 | 3 163 | 194 | 0 | 484 | 0 | 2 485 | 484 |
| K+ | 179 972 | 180 785 | 179 881 | 0 | 813 | 0 | 90 | 813 |
| SO4−− | 4 076 | 4 076 | 4 076 | 0 | 0 | 0 | 0 | 0 |
| Cl− | 164 314 | 165 798 | 160 400 | 0 | 1 484 | 0 | 3 914 | 1 484 |
| H2O | 1 000 000 | 1 007 425 | 1 007 425 | 55 000 | 55 000 | 110 000 | 110 000 | 7 425 |

| | Cycle | | | | |
|---|---|---|---|---|---|
| | A6 | P3 | A2 | A1 | A5 |
| | 4-2-3 | | | | |
| | Condensate | Concentrate | Condensate | Water to | Water to |
| | 1f | 2f | 2f | strip | scrub |
| Qv (m3/h) | 47.6 | 21.0 | 91.4 | 18.7 | 7.4 |
| TDS (mg/L) | 0 | 308 723 | 0 | 0 | 0 |
| Liquid Density(kg/L) | 0.999 | 1.198 | 0.999 | 0.999 | 0.999 |
| Liquid Composition, mg/kg water | | | | | |
| Na+ | 0.0 | 132 874 | 0.0 | 0.0 | 0 |
| K+ | 0.0 | 4 836 | 0.0 | 0.0 | 0 |
| SO4−− | 0.0 | 0 | 0.0 | 0.0 | 0 |
| Cl− | 0.0 | 209 293 | 0.0 | 0.0 | 0 |
| NaCl (g/kg water) | 0.0 | 337.8 | 0.0 | 0.0 | 0.0 |
| KCl (g/kg water) | 0.0 | 9.2 | 0.0 | 0.0 | 0.0 |
| K2SO4 (g/kg water) | 0.0 | 0.0 | 0.0 | 0.0 | 0.0 |
| Liquid Composition, % weight (excluded water) | | | | | |
| Na+ | 0.00% | 9.86% | 0.00% | 0.00% | 0.00% |
| K+ | 0.00% | 0.36% | 0.00% | 0.00% | 0.00% |
| SO4−− | 0.00% | 0.00% | 0.00% | 0.00% | 0.00% |
| Cl− | 0.00% | 15.54% | 0.00% | 0.00% | 0.00% |
| H2O | 100.00% | 74.24% | 100.00% | 100.00% | 100.00% |
| Liquid Composition, % weight (excluded water) | | | | | |
| NaCl | 0.00% | 97.34% | 0.00% | 0.00% | 0.00% |
| KCl | 0.00% | 2.66% | 0.00% | 0.00% | 0.00% |
| K2SO4 | 0.00% | 0.00% | 0.00% | 0.00% | 0.00% |
| Liquid Composition, mg/L solution | | | | | |
| Na+ | 0 | 118 216 | 0 | 0 | 0 |
| K+ | 0 | 4 302 | 0 | 0 | 0 |
| SO4−− | 0 | 0 | 0 | 0 | 0 |
| Cl− | 0 | 186 204 | 0 | 0 | 0 |
| H2O | 999 000 | 889 683 | 999 000 | 999 000 | 999 000 |
| Ionic Flows, kg/h | | | | | |
| Na+ | 0 | 2 485 | 0 | 0 | 0 |
| K+ | 0 | 90 | 0 | 0 | 0 |
| SO4−− | 0 | 0 | 0 | 0 | 0 |
| Cl− | 0 | 3 914 | 0 | 0 | 0 |
| H2O | 47 575 | 18 700 | 91 300 | 18 700 | 7 425 |

By comparison with Table 1, it can be seen that the P3 concentrate obtained with two washing stages contains more NaCl (97.34% by mass) than the P3 concentrate obtained with a single washing stage (91.81% by mass).

### EXAMPLE 6

In this example, the salt to be selectively extracted is potassium chloride KCl.

The organic phase O comprises:
as an extractant of the K⁺ ion, 4-tert-butyl-Calix[6]arene acid hexaethyl ester (C₉₀H₁₂₀O₁₈, CAS no: 92003-62-8) at a concentration of 0.175 M (mol/L) and whose log K for the K⁺ ion in methanol is 4.8;
as an anionic solvating agent, N-(3,4-dichlorophenyl)-octanamide (C₁₄H₁₉Cl₂NO, CAS No: 730-25-6) at a concentration of 0.525 M and with a pKa in water of 13.63+/−0.70; and
1-chloro-2-bromo-benzene as a diluent.

The organic phase has a density of 1.43 g/L at 20° C.

The brine to be treated includes potassium chloride to be extracted as well as sodium chloride. The brine has a salinity of 168 g/L, including 62.7 g/L of Na⁺ and 4.53 g/L of K⁺.

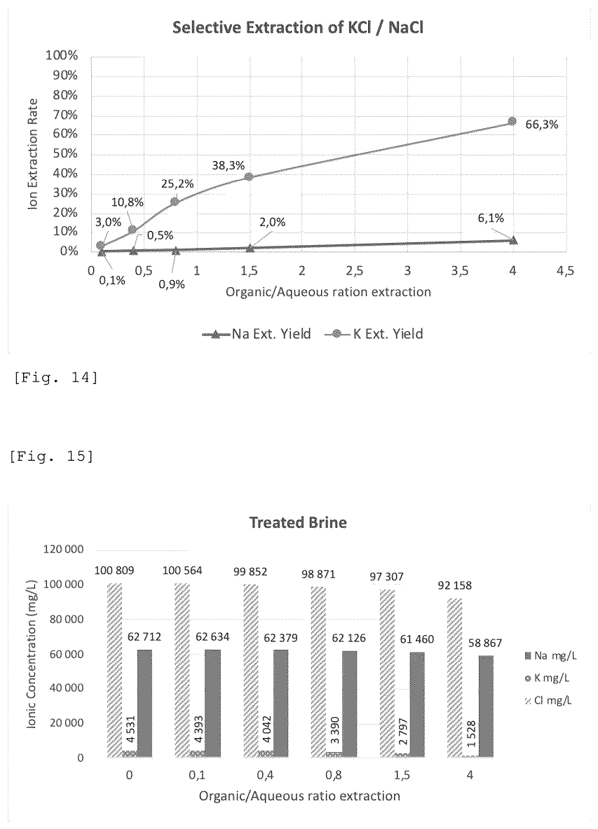

By contacting this brine at room temperature (20° C.) with volume ratios of the organic phase as used in relation to the aqueous brine (O/A)_{extraction} of 0.1; 0.4; 0.8; 1.5 and 4, a good relative extraction of potassium, in the form of KCl, was obtained in relation to sodium, or NaCl, as shown in the graph in FIG. 14.

This extraction of potassium is selective without modifying the sodium concentration, as shown in FIG. 15. The sodium concentration remains stable at around 62 g/L for tests with (O/A)_{extraction} ratios of 0.1, 0.4, 0.8 and 1.5 and a potassium concentration of 2.8 g/L in the brine treated with a (O/A)_{extraction} ratio of 1.5.

FIG. 16 shows the ionic concentrations of the various compounds in the organic phase after extraction at 20° C. KCl is majority in the organic phase for a (O/A)_{extraction} ratio of less than 2.

Then, in order to demonstrate the very low holding of NaCl within the organic phase, the formulation loaded with Na, K and Cl was considered after extraction at a (O/A)_{extraction} ratio of 0.8 and scrubbing at room temperature (20° C.) with very small quantities of water ranging from 1% to 20% of the volume of the organic phase, also noted as the (A/O)_{scrubbing} ratio.

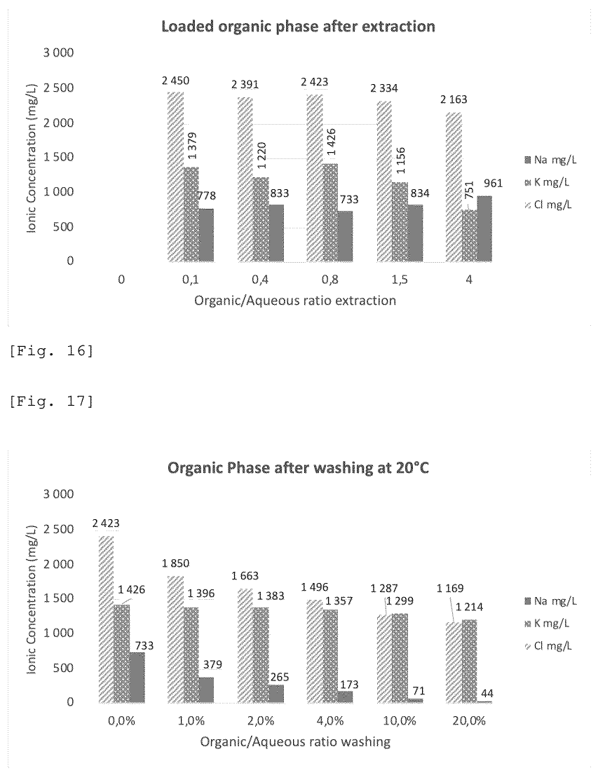

The results are shown in FIG. 17. It appears that as soon as the organic phase is brought into contact with 1% volume of water, 48.3% of the NaCl absorbed in the organic phase returns to the water, compared with only 2.1% of the KCl absorbed.

It also appears that with 4% volume of water, in one washing stage, 76.4% of NaCl is desorbed/transferred to water compared with 4.9% of KCl (and 90.3% of NaCl desorbed with 10% water compared with 8.9% of KCl desorbed).

It can also be seen that KCl is difficult to desorb at room temperature, with only 14.8% of the KCl transferred to water when the volume of water is 20% of the organic phase.

In order to allow the KCl to pass into the aqueous phase and to regenerate the organic phase, hot regeneration is used, at 80° C., of the formulation resulting from washing with 4% of the volume of water, by bringing into contact a volume of hot water of 2%, 5%, 10%, 20% and 50% of the volume of the organic phase, this ratio being noted (A/O)_{regeneration}.

The results obtained are shown in FIG. 18, which shows that with 20% water by volume, 83.7% of the KCl was desorbed from the organic phase (compared with 14.8% previously at 20° C.).

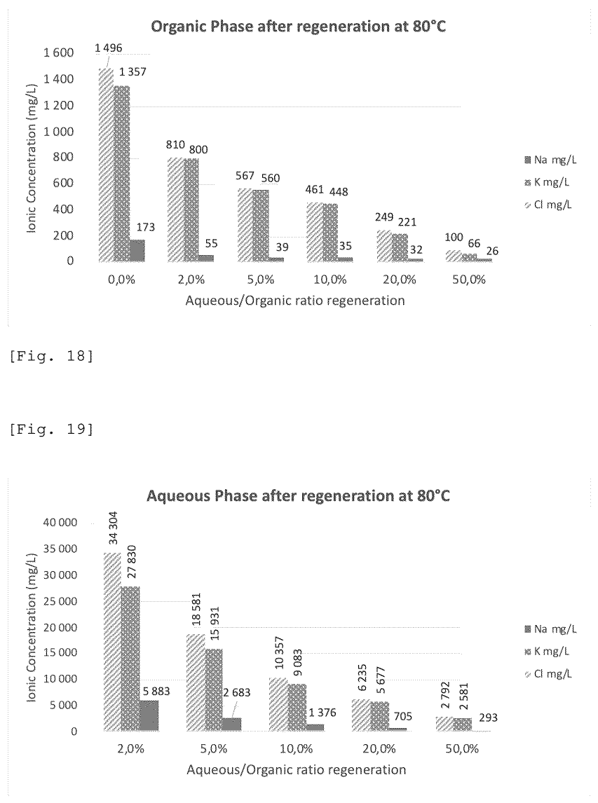

FIG. 19 shows the ionic concentrations of the brine as obtained after hot regeneration at 80° C. After a washing stage with a (A/O)_{washing} ratio of 4%, the brine obtained from hot regeneration is made up of 78% to 90% KCl by mass, which enables the KCl to be purified and KCl to be produced for upgrading.

A parametric study was carried out on these cycles 4-1-3 (cycle of Example 3 with three theoretical stages for hot water regeneration-desorption) and 4-2-3 (cycle with two cold water washing operations and three theoretical stages for hot water regeneration-desorption).

The results of cycle 4-1-3 are shown in FIG. 20.

By extending the curves to the left, i.e. at a (A/O)_{wash} ratio tending towards 0, we would have the performance of a cycle without washing with water 4-0-3. It is clear here that this washing, carried out by increasing the (A/O)_{washing} ratio, makes it possible to increase the purity of the KCl produced at the outlet of the regeneration columns up to a high level of around 91% KCl by mass (excluding water). Furthermore, for sufficiently high (O/A)_{extraction} ratios, the KCl extraction rate can be maintained at over 90% while increasing the purity of the KCl de-extracted by washing with water at room temperature (20° C. here). For this cycle 4-1-3, the selected sizing point gives a KCl extraction yield of 85.0% for a KCl purity of 78.5% by mass, with a (O/A)_{extraction} ratio of 2.2 and a (A/O)_{washing} ratio of 5% (circled points).

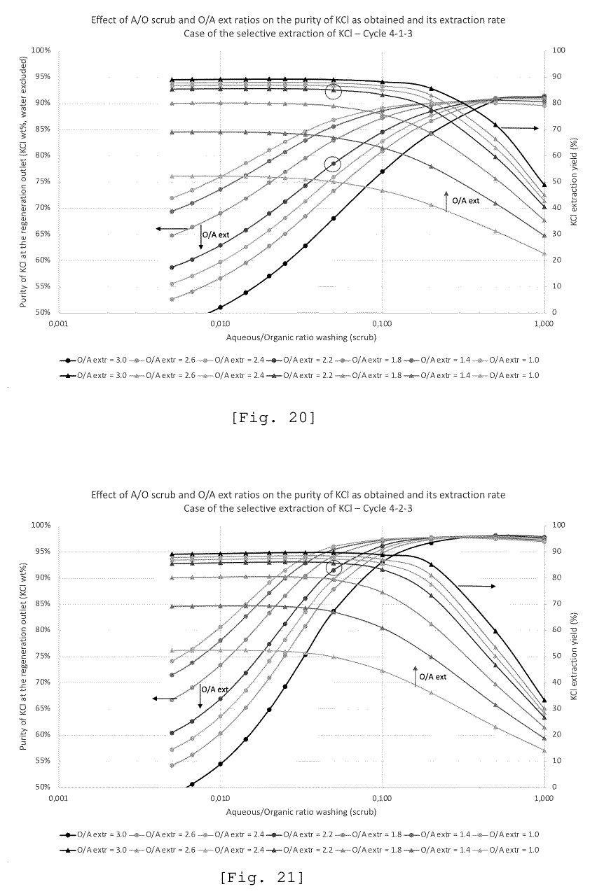

FIG. 21 shows the effect of adding a second countercurrent scrubbing stage at room temperature. The addition of a second scrubbing stage at room temperature, by switching from cycle 4-1-3 to cycle 4-2-3, enables further improvement in the performance of the process to obtain both a high potassium extraction yield and even higher purity of the KCl produced (high level at 98% KCl by mass) at the outlet of the regeneration stage (strip).

For this cycle 4-2-3, the selected sizing point gives a KCl extraction yield of 85.6% for a KCl purity of 91.5% by mass with a (O/A)_{extraction} ratio of 2.2 and a (A/O)_{washing} ratio of 5% (circled points).

Table 3 shows the material balance for a cycle 4-1-3 with a (O/A)_{extraction} ratio of 2.2, a (A/O)_{washing} ratio of 5% and a (A/O)_{regeneration} ratio of 10%.

TABLE 3

| | Cycle | | | | | | | |
|---|---|---|---|---|---|---|---|---|
| | S1 | S2 | S6 | A7 | S7 | A3 | P2 | S8 |
| | 4-1-3 | | | | | | | |
| | Feed | Feed Brine | | Scrub | Scrub | Strip | Strip | Concentrate |
| | Brine | in TSSA | Raffinate | Inlet | Outlet | Inlet | outlet | 1f |
| Qv (m3/h) | 1052.9 | 1065.9 | 1061.1 | 110.1 | 110.4 | 220.2 | 221.0 | 13.0 |
| TDS (mg/L) | 155 247 | 157 207 | 146 061 | 0 | 37 211 | 0 | 38 374 | 315 641 |
| Liquid Density(kg/L) | 1.105 | 1.106 | 1.099 | 0.999 | 1.033 | 0.999 | 1.034 | 1.203 |
| Liquid Composition, mg/kg water | | | | | | | | |
| Na+ | 61 222 | 61 956 | 59 812 | 0 | 13 184 | 0 | 3 266 | 125 559 |
| K+ | 4 105 | 4 278 | 609 | 0 | 2 018 | 0 | 15 861 | 19 222 |
| Cl− | 98 134 | 99 423 | 92 790 | 0 | 22 161 | 0 | 19 419 | 211 057 |
| NaCl (g/kg water) | 155.6 | 157.5 | 152.1 | 0.0 | 33.5 | 0.0 | 8.3 | 319.2 |
| KCl (g/kg water) | 7.8 | 8.2 | 1.2 | 0.0 | 3.8 | 0.0 | 30.2 | 36.7 |
| Liquid Composition, % weight (excluded water) | | | | | | | | |
| Na+ | 5.26% | 5.32% | 5.19% | 0.00% | 1.27% | 0.00% | 0.31% | 9.26% |
| K+ | 0.35% | 0.37% | 0.05% | 0.00% | 0.19% | 0.00% | 1.53% | 1.42% |
| Cl− | 8.43% | 8.53% | 8.05% | 0.00% | 2.14% | 0.00% | 1.87% | 15.57% |
| H2O | 85.95% | 85.79% | 86.71% | 100.00% | 96.40% | 100.00% | 96.29% | 73.76% |
| Liquid Composition, % weight (excluded water) | | | | | | | | |
| NaCl | 95.21% | 95.08% | 99.24% | 0.00% | 89.70% | 0.00% | 21.54% | 89.70% |
| KCl | 4.79% | 4.92% | 0.76% | 0.00% | 10.30% | 0.00% | 78.46% | 10.30% |
| Liquid Composition, mg/L solution | | | | | | | | |
| Na+ | 58 145 | 58 796 | 57 021 | 0 | 13 130 | 0 | 3 252 | 111 375 |
| K+ | 3 899 | 4 060 | 581 | 0 | 2 010 | 0 | 15 790 | 17 051 |
| Cl− | 93 203 | 94 351 | 88 460 | 0 | 22 071 | 0 | 19 332 | 187 215 |
| H2O | 949 751 | 948 985 | 953 332 | 999 000 | 995 942 | 999 000 | 995 549 | 887 033 |
| Ionic Flows, kg/h | | | | | | | | |
| Na+ | 61 222 | 62 672 | 60 503 | 0 | 1 450 | 0 | 719 | 1 450 |
| K+ | 4 105 | 4 327 | 616 | 0 | 222 | 0 | 3 489 | 222 |
| Cl− | 98 134 | 100 572 | 93 862 | 0 | 2 438 | 0 | 4 272 | 2 438 |
| H2O | 1 000 000 | 1 011 550 | 1 011 550 | 110 000 | 110 000 | 220 000 | 220 000 | 11 550 |

| | Cycle | | | | |
|---|---|---|---|---|---|
| | A6 | P3 | A2 | A1 | A5 |
| | 4-1-3 | | | | |
| | Condensate | Concentrate | Condensate | Water to | Water to |
| | 1f | 2f | 2f | strip | scrub |
| Qv (m3/h) | 98.5 | 28.3 | 194.9 | 25.3 | 11.6 |
| TDS (mg/L) | 0 | 299 580 | 0 | 0 | 0 |
| Liquid Density(kg/L) | 0.999 | 1.193 | 0.999 | 0.999 | 0.999 |
| Liquid Composition, mg/kg water | | | | | |
| Na+ | 0.0 | 28 401 | 0.0 | 0.0 | 0 |
| K+ | 0.0 | 137 918 | 0.0 | 0.0 | 0 |
| Cl− | 0.0 | 168 858 | 0.0 | 0.0 | 0 |
| NaCl (g/kg water) | 0.0 | 72.2 | 0.0 | 0.0 | 0.0 |
| KCl (g/kg water) | 0.0 | 263.0 | 0.0 | 0.0 | 0.0 |
| Liquid Composition, % weight (excluded water) | | | | | |
| Na+ | 0.00% | 2.13% | 0.00% | 0.00% | 0.00% |
| K+ | 0.00% | 10.33% | 0.00% | 0.00% | 0.00% |
| Cl− | 0.00% | 12.65% | 0.00% | 0.00% | 0.00% |
| H2O | 100.00% | 74.90% | 100.00% | 100.00% | 100.00% |
| Liquid Composition, % weight (excluded water) | | | | | |
| NaCl | 0% | 21.54% | 0% | 0% | 0% |
| KCl | 0% | 78.46% | 0% | 0% | 0% |
| Liquid Composition, mg/L solution | | | | | |
| Na+ | 0 | 25 385 | 0 | 0 | 0 |
| K+ | 0 | 123 271 | 0 | 0 | 0 |
| Cl− | 0 | 150 924 | 0 | 0 | 0 |
| H2O | 999 000 | 893 796 | 999 000 | 999 000 | 999 000 |
| Ionic Flows, kg/h | | | | | |
| Na+ | 0 | 719 | 0 | 0 | 0 |
| K+ | 0 | 3 489 | 0 | 0 | 0 |
| Cl− | 0 | 4 272 | 0 | 0 | 0 |
| H2O | 98 450 | 25 300 | 194 700 | 25 300 | 11 550 |

This table shows that the raffinate S6 now contains only 0.76% by mass of KCl, the quantity of Na⁺ ions in it being practically unchanged from the quantity present in the brine to be treated S1.

Table 4 shows the material balance for a cycle 4-2-3 with a (O/A)_{extraction} ratio of 2.2, a (A/O)_{washing} ratio of 5% and a (A/O)_{regeneration} ratio of 10%.

TABLE 4

| | Cycle | | | | | | | |
|---|---|---|---|---|---|---|---|---|
| | S1 | S2 | S6 | A7 | S7 | A3 | P2 | S8 |
| | 4-2-3 | | | | | | | |
| | Feed | Feed Brine | | Scrub | Scrub | Strip | Strip | Concentrate |
| | Brine | in TSSA | Raffinate | Inlet | Outlet | Inlet | outlet | 1f |
| Qv (m3/h) | 1052.9 | 1070.2 | 1065.3 | 110.1 | 111.0 | 220.2 | 220.5 | 17.3 |
| TDS (mg/L) | 155 247 | 157 806 | 146 560 | 0 | 48 947 | 0 | 33 224 | 313 170 |
| Liquid Density(kg/L) | 1.105 | 1.107 | 1.100 | 0.999 | 1.040 | 0.999 | 1.031 | 1.201 |
| Liquid Composition, mg/kg water | | | | | | | | |
| Na+ | 61 222 | 62 219 | 60 051 | 0 | 17 779 | 0 | 1 119 | 126 993 |
| K+ | 4 105 | 4 280 | 582 | 0 | 2 191 | 0 | 15 974 | 15 651 |
| Cl− | 98 134 | 99 831 | 93 133 | 0 | 29 404 | 0 | 16 211 | 210 030 |
| NaCl (g/kg water) | 155.6 | 158.2 | 152.7 | 0.0 | 45.2 | 0.0 | 2.8 | 322.8 |
| KCl (g/kg water) | 7.8 | 8.2 | 1.1 | 0.0 | 4.2 | 0.0 | 30.5 | 29.8 |
| Liquid Composition, % weight (excluded water) | | | | | | | | |
| Na+ | 5.26% | 5.33% | 5.20% | 0.00% | 1.69% | 0.00% | 0.11% | 9.39% |
| K+ | 0.35% | 0.37% | 0.05% | 0.00% | 0.21% | 0.00% | 1.55% | 1.16% |
| Cl− | 8.43% | 8.56% | 8.07% | 0.00% | 2.80% | 0.00% | 1.57% | 15.53% |
| H2O | 85.95% | 85.74% | 86.67% | 100.00% | 95.29% | 100.00% | 96.78% | 73.93% |
| Liquid Composition, % weight (excluded water) | | | | | | | | |
| NaCl | 95.21% | 95.09% | 99.28% | 0.00% | 91.54% | 0.00% | 8.54% | 91.54% |
| KCl | 4.79% | 4.91% | 0.72% | 0.00% | 8.46% | 0.00% | 91.46% | 8.46% |
| Liquid Composition, mg/L solution | | | | | | | | |
| Na+ | 58 145 | 59 031 | 57 236 | 0 | 17 625 | 0 | 1 117 | 112 768 |
| K+ | 3 899 | 4 061 | 555 | 0 | 2 172 | 0 | 15 935 | 13 898 |
| Cl− | 93 203 | 94 715 | 88 769 | 0 | 29 150 | 0 | 16 172 | 186 504 |
| H2O | 949 751 | 948 750 | 953 136 | 999 000 | 991 349 | 999 000 | 997 565 | 887 986 |
| Ionic Flows, kg/h | | | | | | | | |
| Na+ | 61 222 | 63 177 | 60 975 | 0 | 1 956 | 0 | 246 | 1 956 |
| K+ | 4 105 | 4 346 | 591 | 0 | 241 | 0 | 3 514 | 241 |
| Cl− | 98 134 | 101 368 | 94 567 | 0 | 3 234 | 0 | 3 566 | 3 234 |
| H2O | 1 000 000 | 1 015 400 | 1 015 400 | 110 000 | 110 000 | 220 000 | 220 000 | 15 400 |

| | Cycle | | | | |
|---|---|---|---|---|---|
| | A6 | P3 | A2 | A1 | A5 |
| | 4-2-3 | | | | |
| | Condensate | Concentrate | Condensate | Water to | Water to |
| | 1f | 2f | 2f | strip | scrub |
| Qv (m3/h) | 94.7 | 24.6 | 198.2 | 22.0 | 15.4 |
| TDS (mg/L) | 0 | 297 925 | 0 | 0 | 0 |
| Liquid Density(kg/L) | 0.999 | 1.192 | 0.999 | 0.999 | 0.999 |
| Liquid Composition, mg/kg water | | | | | |
| Na+ | 0.0 | 11 194 | 0.0 | 0.0 | 0 |
| K+ | 0.0 | 159 744 | 0.0 | 0.0 | 0 |
| Cl− | 0.0 | 162 113 | 0.0 | 0.0 | 0 |
| NaCl (g/kg water) | 0.0 | 28.5 | 0.0 | 0.0 | 0.0 |
| KCl (g/kg water) | 0.0 | 304.6 | 0.0 | 0.0 | 0.0 |
| Liquid Composition, % weight (excluded water) | | | | | |
| Na+ | 0.00% | 0.84% | 0.00% | 0.00% | 0.00% |
| K+ | 0.00% | 11.98% | 0.00% | 0.00% | 0.00% |
| Cl− | 0.00% | 12.16% | 0.00% | 0.00% | 0.00% |
| H2O | 100.00% | 75.02% | 100.00% | 100.00% | 100.00% |
| Liquid Composition, % weight (excluded water) | | | | | |
| NaCl | 0% | 8.54% | 0% | 0% | 0% |
| KCl | 0% | 91.46% | 0% | 0% | 0% |
| Liquid Composition, mg/L solution | | | | | |
| Na+ | 0 | 10 014 | 0 | 0 | 0 |
| K+ | 0 | 142 896 | 0 | 0 | 0 |
| Cl− | 0 | 145 015 | 0 | 0 | 0 |
| H2O | 999 000 | 894 532 | 999 000 | 999 000 | 999 000 |
| Ionic Flows, kg/h | | | | | |
| Na+ | 0 | 246 | 0 | 0 | 0 |
| K+ | 0 | 3 514 | 0 | 0 | 0 |
| Cl− | 0 | 3 566 | 0 | 0 | 0 |
| H2O | 94 600 | 22 000 | 198 000 | 22 000 | 15 400 |

Comparison with Table 3 shows that the concentrate P3 obtained with two washing stages contains more KCl (91.46% by mass) than the concentrate P3 obtained with a single washing stage (78.46% by mass).

Examples 5 and 6 show that the organic selective extraction formulations and the process used according to the invention are capable of obtaining effluents that are relatively pure in NaCl and/or KCl.

### EXAMPLE 7

In this example, the salt to be selectively extracted is lithium chloride LiCl.

The organic phase O comprises
as an extractant for the Li ion⁺, the lithium ionophore VIII, also known as N,N,N′,N′,N″,N″-Hexacyclohexyl-4,4′,4″-propylidynetris(3-oxabutyramide) (C₄₈H₈₃N₃O₆, CAS No: 133338-85-9) at a concentration of 0.25 M (mol/L) and with a log K in methanol of 2.2;
as an anionic solvating agent, N-(3,5-dichlorophenyl)-octanamide (C₁₄H₁₉Cl₂NO, CAS No: 20198-46-3) at a concentration of 0.75 M and with a pKa in water of 13.83+/−0.70; and
1-chloro-2-bromo-benzene as a diluent.

The organic phase has a density of 1.43 g/L at 20° C.

The brine to be treated comprises lithium chloride. This brine is a brine containing Li⁺, Na⁺, K⁺, Mg²⁺, Ca²⁺, Boron, SO₄²⁻ and Cl⁻ with a salinity of 209.81 g/L, including 2.26 g/L of Li⁺, 2.26 g/L of Na⁺ and 107 g/L of K⁺.

Since most lithium-rich brines have a Ca/Li molar ratio of less than 0.5 (the exceptions are: Maricunga, Chile: Ca/Li=2; Tres Quebradas, Argentina: Ca/Li=7.4) and that the Na/Li molar ratio can vary from 1 to 150, it seems that the key to direct lithium extraction is to have a very good selectivity between lithium and sodium.

By way of illustration, the average brine composition of the Maricunga Blanco project was examined, with representative Na/Li and Ca/Li ratios (22.8 and 2.1 respectively). Table 5 shows the minimum, average and maximum brine concentrations for the Maricunga Blanco project.

TABLE 5

| | HCO₃ | | | | | | | | |
|---|---|---|---|---|---|---|---|---|---|
| | (as | | | | | | | | |
| | CaCO₃) | B | Ca²⁺ | Cl⁻ | Li⁺ | Mg²⁺ | K⁺ | Na⁺ | SO₄²⁻ |
| Analyte | mg/L | mg/L | mg/L | mg/L | mg/L | mg/L | mg/L | mg/L | mg/L |
| Max | 2730 | 1992 | 36950 | 230902 | 3375 | 21800 | 20640 | 104800 | 2960 |
| Avg | 471 | 596 | 12853 | 190930 | 1146 | 7462 | 8292 | 85190 | 709 |
| Min | 76 | 234 | 4000 | 89441 | 460 | 2763 | 1940 | 37750 | 259 |

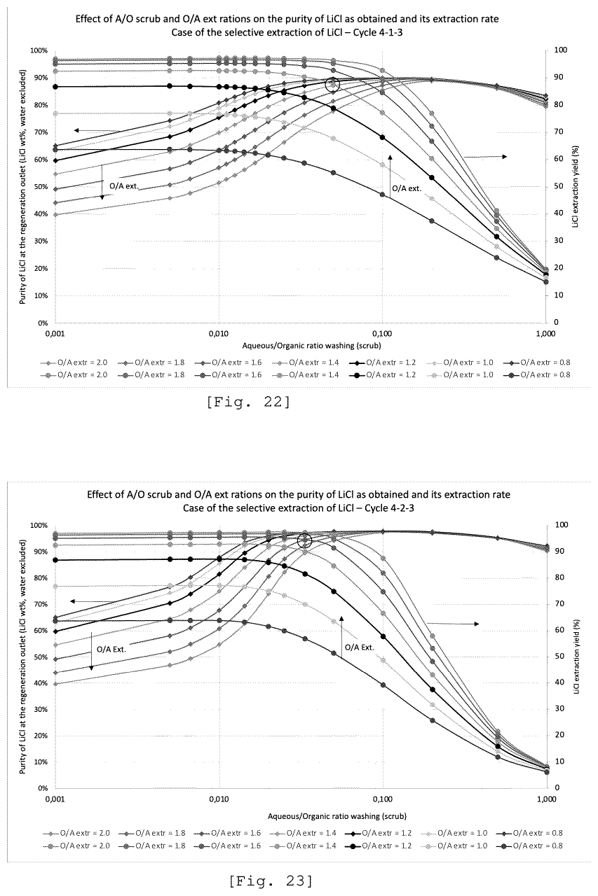

Laboratory tests combined with the reconstruction of ionic balances for cycles 4-0-3 (in the case of Example 1), 4-1-3 (in the case of Example 3) and 4-2-3, all operating at 20° C. for lithium extraction and washing when the latter is carried out, and at 80° C. for desorption, show from FIGS. 22 and 23 that the lithium yield can be as high as 97% and that the purity of the LiCl produced depends on three complementary parameters, the (O/A)_{extraction} ratio, the choice of cycle and the (A/O)_{washing} ratio.

The purity of the LiCl product (in % by mass, excluding water) varies from a maximum of 65% for cycle 4-0-3, to 90% for cycle 4-1-3 and 97.5% for cycle 4-2-3.

As can be seen in these two graphs, increasing the (O/A)_{extraction} ratio increases the lithium yield while reducing the purity of the LiCl product by co-extraction of NaCl and CaCl₂.

The surprising point is that when pure water is used for the washing stages (for one or two washing stages in series), the purity of the LiCl product is very considerably improved with a very limited loss in lithium yield when the (A/O)_{washing} ratio remains below 10% (0.100) for cycle 4-1-3 and below 5% (0.050) for cycle 4-2-3.

FIG. 23 and Table 6 show the great advantage of washing with water to improve the purity of LiCl production. The brine compositions are given at the outlet of the desorption column (P1).

TABLE 6

| | Cycle 4- | Cycle 4- | Cycle 4- | Cycle 4- | Cycle 4- | Cycle 4- |
|---|---|---|---|---|---|---|
| | 0-3 | 1-3 | 2-3 | 0-3 | 1-3 | 2-3 |
| | (Y/A) | (Y/A) | (Y/A) | (Y/A) | (Y/A) | (Y/A) |
| | regen = | regen = | regen = | regen = | regen = | regen = |
| | 10 | 10 | 10 | 15 | 15 | 15 |
| (A/O)_{washing} | 0.0% | 5.0% | 5.0% | 0.0% | 5.0% | 5.0% |
| Li yield | 92.4% | 90.5% | 94.8% | 84.4% | 83.1% | 80.7% |
| Mass % LiCl | 54.6% | 85.9% | 95.5% | 54.5% | 86.0% | 96.9% |
| Li (mg/kg by | 8177 | 7474 | 6531 | 11209 | 10294 | 9997 |
| mass) | | | | | | |
| Na (mg/kg by | 8244 | 1771 | 476 | 11399 | 2427 | 491 |
| mass) | | | | | | |
| K (mg/kg by | 8 | 0 | 0 | 12 | 0 | 0 |
| mass) | | | | | | |
| Mg (mg/kg by | 7 | 0 | 0 | 11 | 0 | 0 |
| mass) | | | | | | |
| Ca (mg/kg by | 7423 | 1071 | 237 | 10157 | 1473 | 263 |
| mass) | | | | | | |
| SO4 (mg/kg | 1 | 0 | 0 | 1 | 0 | 0 |
| by mass) | | | | | | |
| Cl (mg/kg by | 67640 | 42800 | 34511 | 92841 | 58925 | 52287 |
| mass) | | | | | | |
| LiCl (g/kg | 50 | 46 | 40 | 68 | 63 | 61 |
| by mass) | | | | | | |
| Regeneration | 92.0 | 59.0 | 47.8 | 124.5 | 80.4 | 71.7 |
| osmotic | | | | | | |
| pressure | | | | | | |
| (bara) | | | | | | |
| Density | 1.062 | 1.038 | 1.032 | 1.080 | 1.048 | 1.042 |
| (kg/L) | | | | | | |

Sodium and calcium salts are removed from LiCl production when lithium is maintained. The application of this process provides a high level of protection for local water resources, both the water contained in the lithium-rich brine (as the water in this brine is not evaporated for reconcentration purposes if the lithium content in the lithium-rich brine to be treated is greater than 100 mg/kg of water, preferably greater than 150 mg/kg of water) or of the fresh water required to operate the process for the washing and regeneration-desorption stages, as a high purity of the LiCl product and a low extraction rate of the NaCl and CaCl₂ allow efficient recycling of the water via the use of a reverse osmosis membrane unit, a membrane distillation unit and/or a multiple-effect evaporation-condensation unit and/or a unit for water absorption by a temperature-regenerable organic phase and/or a combination of at least two of these units on the output stream(s) of the washing and regeneration-desorption stages.

Tables 7 and 8 give a detailed mass balance for cycles 4-1-3 and 4-2-3 when operating at temperatures of 20° C. for extraction and washing operations, and 80° C. in the desorption columns for regeneration of the organic phase. For these two cycles, fresh water recycling is 84% and 87% respectively, generating very low fresh water requirements of 6.03 tons of water/ton LiCl and 5.61 tons of water/ton LiCl respectively (and 37.7 and 43.2 tons of water/ton LiCl without fresh water recycling). It should be noted that K⁺, Mg²⁺ and SO₄²⁻ do not appear in the production of effluent P3 and that boron B is not presented as 100% of it remains in the raffinate B6. Here, the LiCl produced is 85.9% by mass pure for cycle 4-1-3 (O/A)_{regeneration=10} and 95.5% by mass pure for cycle 4-2-3 (O/A)_{regeneration=10} in the effluent P3 when water is excluded.

It should be noted that reducing the flowrate of the regeneration water by increasing the O/A ratio_{regeneration} from 10 to 15 generates more or less the same purity of the LiCl as produced, but reduces the lithium extraction yield by around ten percentage points. On the other hand, the LiCl as produced is more concentrated, with a gain of up to 50% (61 g LiCl/kg water compared with 40 g LiCl/kg).

TABLE 7

| | Cycle | | | | | | | |
|---|---|---|---|---|---|---|---|---|
| | S1 | S2 | S6 | A7 | S7 | A3 | P2 | S8 |
| | 4-1-3 | | | | | | | |
| | Feed | Feed Brine | | Scrub | Scrub | Strip | Strip | Concentrate |
| | Brine | in TSSA | Raffinate | Inlet | Outlet | Inlet | outlet | 1f |
| Qv (m3/h) | 228.4 | 231.5 | 230.3 | 15.4 | 15.6 | 30.8 | 31.2 | 3.2 |
| TDS (mg/L) | 300 954 | 301 540 | 291 292 | 0 | 69 423 | 0 | 52 358 | 344 010 |
| Liquid Density(kg/L) | 1.198 | 1.198 | 1.193 | 0.999 | 1.053 | 0.999 | 1.038 | 1.221 |
| Liquid Composition, mg/kg water | | | | | | | | |
| Li+ | 1 239 | 1 442 | 117 | 0 | 2 955 | 0 | 7 474 | 16 419 |
| Na+ | 93 614 | 93 191 | 92 105 | 0 | 11 132 | 0 | 1 771 | 61 844 |
| K+ | 9 046 | 8 927 | 8 926 | 0 | 16 | 0 | 0 | 88 |
| Mg++ | 8 044 | 7 938 | 7 936 | 0 | 14 | 0 | 0 | 78 |
| Ca++ | 14 819 | 15 267 | 14 463 | 0 | 8 718 | 0 | 1 071 | 48 435 |
| SO4−− | 791 | 780 | 780 | 0 | 1 | 0 | 0 | 8 |
| Cl− | 207 998 | 208 760 | 198 893 | 0 | 47 741 | 0 | 42 800 | 265 229 |
| H2O | 1 000 000 | 1 000 000 | 1 000 000 | 1 000 000 | 1 000 000 | 1 000 000 | 1 000 000 | 1 000 000 |
| LiCl (g/kg water) | 7.6 | 8.8 | 0.7 | 0.0 | 18.1 | 0.0 | 45.6 | 100.3 |
| NaCl (g/kg water) | 238.0 | 236.9 | 234.1 | 0.0 | 28.3 | 0.0 | 4.5 | 157.2 |
| CaCl2 (g/kg water) | 41.0 | 42.3 | 40.1 | 0.0 | 24.1 | 0.0 | 3.0 | 134.1 |
| Liquid Composition, % weight | | | | | | | | |
| Li+ | 0.09% | 0.11% | 0.01% | 0.00% | 0.28% | 0.00% | 0.71% | 1.18% |
| Na+ | 7.01% | 6.97% | 6.96% | 0.00% | 1.04% | 0.00% | 0.17% | 4.44% |
| K+ | 0.68% | 0.67% | 0.67% | 0.00% | 0.00% | 0.00% | 0.00% | 0.01% |
| Mg++ | 0.60% | 0.59% | 0.60% | 0.00% | 0.00% | 0.00% | 0.00% | 0.01% |
| Ca++ | 1.11% | 1.14% | 1.09% | 0.00% | 0.81% | 0.00% | 0.10% | 3.48% |
| SO4−− | 0.06% | 0.06% | 0.06% | 0.00% | 0.00% | 0.00% | 0.00% | 0.00% |
| Cl− | 15.57% | 15.62% | 15.03% | 0.00% | 4.46% | 0.00% | 4.06% | 19.05% |
| H2O | 74.88% | 74.83% | 75.57% | 100.00% | 93.41% | 100.00% | 94.96% | 71.83% |
| Liquid Composition, % weight (excluded water) | | | | | | | | |
| LiCl | 2.26% | 2.62% | 0.00% | 0% | 25.58% | 0% | 85.94% | 25.58% |
| NaCl | 70.92% | 70.44% | 72.44% | 0% | 40.10% | 0% | 8.47% | 40.10% |
| CaCl2 | 12.23% | 12.57% | 12.39% | 0% | 34.21% | 0% | 5.58% | 34.21% |
| Ionic Flows, kg/h | | | | | | | | |
| Li+ | 254 | 299 | 24 | 0 | 45 | 0 | 230 | 45 |
| Na+ | 19 174 | 19 345 | 19 120 | 0 | 171 | 0 | 54 | 171 |
| K+ | 1 853 | 1 853 | 1 853 | 0 | 0 | 0 | 0 | 0 |
| Mg++ | 1 648 | 1 648 | 1 648 | 0 | 0 | 0 | 0 | 0 |
| Ca++ | 3 035 | 3 169 | 3 002 | 0 | 134 | 0 | 33 | 134 |
| SO4−− | 162 | 162 | 162 | 0 | 0 | 0 | 0 | 0 |
| Cl− | 42 603 | 43 336 | 41 288 | 0 | 733 | 0 | 1 315 | 733 |
| H2O | 204 823 | 207 588 | 207 588 | 15 362 | 15 362 | 30 723 | 30 723 | 2 765 |

| | Cycle | | | | |
|---|---|---|---|---|---|
| | A6 | P3 | A2 | A1 | A5 |
| | 4-1-3 | | | | |
| | Condensate | Concentrate | Condensate | Water to | Water to |
| | 1f | 2f | 2f | strip | scrub |
| Qv (m3/h) | 12.6 | 5.3 | 26.1 | 4.6 | 2.8 |
| TDS (mg/L) | 0 | 306 500 | 0 | 0 | 0 |
| Liquid Density(kg/L) | 0.999 | 1.172 | 0.999 | 0.999 | 0.999 |
| Liquid Composition, mg/kg water | | | | | |
| Li+ | 0.0 | 49 825 | 0.0 | 0.0 | 0 |
| Na+ | 0.0 | 11 805 | 0.0 | 0.0 | 0 |
| K+ | 0.0 | 0 | 0.0 | 0.0 | 0 |
| Mg++ | 0.0 | 0 | 0.0 | 0.0 | 0 |
| Ca++ | 0.0 | 7 141 | 0.0 | 0.0 | 0 |
| SO4−− | 0.0 | 0 | 0.0 | 0.0 | 0 |
| Cl− | 0.0 | 285 331 | 0.0 | 0.0 | 0 |
| H2O | 1 000 000 | 1 000 000 | 1 000 000 | 1 000 000 | 1 000 000 |
| LiCl (g/kg water) | 0.0 | 304.3 | 0.0 | 0.0 | 0.0 |
| NaCl (g/kg water) | 0.0 | 30.0 | 0.0 | 0.0 | 0.0 |
| CaCl2 (g/kg water) | 0.0 | 19.8 | 0.0 | 0.0 | 0.0 |
| Liquid Composition, % weight | | | | | |
| Li+ | 0.00% | 3.68% | 0.00% | 0.00% | 0.00% |
| Na+ | 0.00% | 0.87% | 0.00% | 0.00% | 0.00% |
| K+ | 0.00% | 0.00% | 0.00% | 0.00% | 0.00% |
| Mg++ | 0.00% | 0.00% | 0.00% | 0.00% | 0.00% |
| Ca++ | 0.00% | 0.53% | 0.00% | 0.00% | 0.00% |
| SO4−− | 0.00% | 0.00% | 0.00% | 0.00% | 0.00% |
| Cl− | 0.00% | 21.07% | 0.00% | 0.00% | 0.00% |
| H2O | 100.00% | 73.85% | 100.00% | 100.00% | 100.00% |
| Liquid Composition, % weight (excluded water) | | | | | |
| LiCl | 0% | 85.94% | 0% | 0% | 0% |
| NaCl | 0% | 8.47% | 0% | 0% | 0% |
| CaCl2 | 0% | 5.58% | 0% | 0% | 0% |
| Ionic Flows, kg/h | | | | | |
| Li+ | 0 | 230 | 0 | 0 | 0 |
| Na+ | 0 | 54 | 0 | 0 | 0 |
| K+ | 0 | 0 | 0 | 0 | 0 |
| Mg++ | 0 | 0 | 0 | 0 | 0 |
| Ca++ | 0 | 33 | 0 | 0 | 0 |
| SO4−− | 0 | 0 | 0 | 0 | 0 |
| Cl− | 0 | 1 315 | 0 | 0 | 0 |
| H2O | 12 597 | 4 609 | 26 115 | 4 609 | 2 765 |

TABLE 8

| | Cycle | | | | | | | |
|---|---|---|---|---|---|---|---|---|
| | S1 | S2 | S6 | A7 | S7 | A3 | P2 | S8 |
| | 4-2-3 | | | | | | | |
| | Feed | Feed Brine | | Scrub | Scrub | Strip | Strip | Concentrate |
| | Brine | in TSSA | Raffinate | Inlet | Outlet | Inlet | outlet | 1f |
| Qv (m3/h) | 207.1 | 210.8 | 209.5 | 16.7 | 17.1 | 33.5 | 33.8 | 3.7 |
| TDS (mg/L) | 300 954 | 302 954 | 290 743 | 0 | 90 115 | 0 | 41 354 | 414 108 |
| Liquid Density(kg/L) | 1.198 | 1.199 | 1.192 | 0.999 | 1.066 | 0.999 | 1.032 | 1.266 |
| Liquid Composition, mg/kg water | | | | | | | | |
| Li+ | 1 239 | 1 512 | 63 | 0 | 3 316 | 0 | 6 531 | 17 453 |
| Na+ | 93 614 | 93 405 | 91 956 | 0 | 15 427 | 0 | 476 | 81 195 |
| K+ | 9 046 | 8 896 | 8 894 | 0 | 16 | 0 | 0 | 84 |
| Mg++ | 8 044 | 7 910 | 7 908 | 0 | 14 | 0 | 0 | 74 |
| Ca++ | 14 819 | 15 617 | 14 528 | 0 | 11 834 | 0 | 237 | 62 282 |
| SO4−− | 791 | 778 | 777 | 0 | 1 | 0 | 0 | 7 |
| Cl− | 207 998 | 209 962 | 198 394 | 0 | 61 719 | 0 | 34 511 | 324 836 |
| H2O | 1 000 000 | 1 000 000 | 1 000 000 | 1 000 000 | 1 000 000 | 1 000 000 | 1 000 000 | 1 000 000 |
| LiCl (g/kg water) | 7.6 | 9.2 | 0.4 | 0.0 | 20.3 | 0.0 | 39.9 | 106.6 |
| NaCl (g/kg water) | 238.0 | 237.4 | 233.8 | 0.0 | 39.2 | 0.0 | 1.2 | 206.4 |
| CaCl2 (g/kg water) | 41.0 | 43.2 | 40.2 | 0.0 | 32.8 | 0.0 | 0.7 | 172.5 |
| Liquid Composition, % weight | | | | | | | | |
| Li+ | 0.09% | 0.11% | 0.00% | 0.00% | 0.30% | 0.00% | 0.63% | 1.17% |
| Na+ | 7.01% | 6.98% | 6.95% | 0.00% | 1.41% | 0.00% | 0.05% | 5.46% |
| K+ | 0.68% | 0.66% | 0.67% | 0.00% | 0.00% | 0.00% | 0.00% | 0.01% |
| Mg++ | 0.60% | 0.59% | 0.60% | 0.00% | 0.00% | 0.00% | 0.00% | 0.00% |
| Ca++ | 1.11% | 1.17% | 1.10% | 0.00% | 1.08% | 0.00% | 0.02% | 4.19% |
| SO4−− | 0.06% | 0.06% | 0.06% | 0.00% | 0.00% | 0.00% | 0.00% | 0.00% |
| Cl− | 15.57% | 15.69% | 15.00% | 0.00% | 5.65% | 0.00% | 3.31% | 21.86% |
| H2O | 74.88% | 74.73% | 75.61% | 100.00% | 91.55% | 100.00% | 95.99% | 67.30% |
| Liquid Composition, % weight (excluded water) | | | | | | | | |
| LiCl | 2.26% | 2.73% | 0.00% | 0% | 21.94% | 0% | 95.53% | 21.94% |
| NaCl | 70.92% | 70.23% | 72.48% | 0% | 42.48% | 0% | 2.90% | 42.48% |
| CaCl2 | 12.23% | 12.79% | 12.47% | 0% | 35.49% | 0% | 1.57% | 35.49% |
| Ionic Flows, kg/h | | | | | | | | |
| Li+ | 230 | 286 | 12 | 0 | 55 | 0 | 218 | 55 |
| Na+ | 17 385 | 17 643 | 17 369 | 0 | 258 | 0 | 16 | 258 |
| K+ | 1 680 | 1 680 | 1 680 | 0 | 0 | 0 | 0 | 0 |
| Mg++ | 1 494 | 1 494 | 1 494 | 0 | 0 | 0 | 0 | 0 |
| Ca++ | 2 752 | 2 950 | 2 744 | 0 | 198 | 0 | 8 | 198 |
| SO4−− | 147 | 147 | 147 | 0 | 0 | 0 | 0 | 0 |
| Cl− | 38 627 | 39 658 | 37 473 | 0 | 1 032 | 0 | 1 154 | 1 032 |
| H2O | 185 706 | 188 882 | 188 882 | 16 714 | 16 714 | 33 427 | 33 427 | 3 176 |

| | Cycle | | | | |
|---|---|---|---|---|---|
| | A6 | P3 | A2 | A1 | A5 |
| | 4-2-3 | | | | |
| | Condensate | Concentrate | Condensate | Water to | Water to |
| | 1f | 2f | 2f | strip | scrub |
| Qv (m3/h) | 13.6 | 4.0 | 30.1 | 3.3 | 3.2 |
| TDS (mg/L) | 0 | 350 752 | 0 | 0 | 0 |
| Liquid Density(kg/L) | 0.999 | 1.191 | 0.999 | 0.999 | 0.999 |
| Liquid Composition, mg/kg water | | | | | |
| Li+ | 0.0 | 65 306 | 0.0 | 0.0 | 0 |
| Na+ | 0.0 | 4 764 | 0.0 | 0.0 | 0 |
| K+ | 0.0 | 0 | 0.0 | 0.0 | 0 |
| Mg++ | 0.0 | 0 | 0.0 | 0.0 | 0 |
| Ca++ | 0.0 | 2 369 | 0.0 | 0.0 | 0 |
| SO4−− | 0.0 | 0 | 0.0 | 0.0 | 0 |
| Cl− | 0.0 | 345 106 | 0.0 | 0.0 | 0 |
| H2O | 1 000 000 | 1 000 000 | 1 000 000 | 1 000 000 | 1 000 000 |
| LiCl (g/kg water) | 0.0 | 398.9 | 0.0 | 0.0 | 0.0 |
| NaCl (g/kg water) | 0.0 | 12.1 | 0.0 | 0.0 | 0.0 |
| CaCl2 (g/kg water) | 0.0 | 6.6 | 0.0 | 0.0 | 0.0 |
| Liquid Composition, % weight | | | | | |
| Li+ | 0.00% | 4.61% | 0.00% | 0.00% | 0.00% |
| Na+ | 0.00% | 0.34% | 0.00% | 0.00% | 0.00% |
| K+ | 0.00% | 0.00% | 0.00% | 0.00% | 0.00% |
| Mg++ | 0.00% | 0.00% | 0.00% | 0.00% | 0.00% |
| Ca++ | 0.00% | 0.17% | 0.00% | 0.00% | 0.00% |
| SO4−− | 0.00% | 0.00% | 0.00% | 0.00% | 0.00% |
| Cl− | 0.00% | 24.35% | 0.00% | 0.00% | 0.00% |
| H2O | 100.00% | 70.54% | 100.00% | 100.00% | 100.00% |
| Liquid Composition, % weight (excluded water) | | | | | |
| LiCl | 0% | 95.53% | 0% | 0% | 0% |
| NaCl | 0% | 2.90% | 0% | 0% | 0% |
| CaCl2 | 0% | 1.57% | 0% | 0% | 0% |
| Ionic Flows, kg/h | | | | | |
| Li+ | 0 | 218 | 0 | 0 | 0 |
| Na+ | 0 | 16 | 0 | 0 | 0 |
| K+ | 0 | 0 | 0 | 0 | 0 |
| Mg++ | 0 | 0 | 0 | 0 | 0 |
| Ca++ | 0 | 8 | 0 | 0 | 0 |
| SO4−− | 0 | 0 | 0 | 0 | 0 |
| Cl− | 0 | 1 154 | 0 | 0 | 0 |
| H2O | 13 538 | 3 343 | 30 084 | 3 343 | 3 176 |

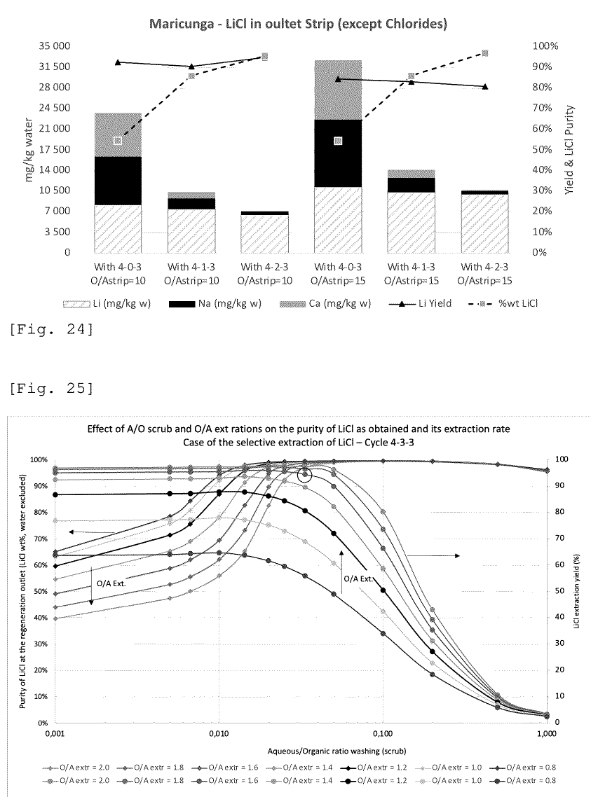

In addition to FIG. 25, which presents the parametric study of the possible performances for the cycle 4-3-3, Table 9 and FIG. 24 provide a summary of the optimum dimensions adopted for the case of the selective lithium extraction for the Maricunga brine, for cycles with four extraction stages and three theoretical regeneration stages for 0, 1, 2 and 3 washing stages respectively.

It appears that the selectivity of the chosen organic formulation enables the LiCl content of the brine to be increased from 2.26% by mass to 51.6% by mass in the brine as produced at the outlet of the regeneration process (strip).

It also appears that the use of an increasing number of countercurrent washing stages enables the purification of the LiCl as produced to be completed, rising from 51.6% by mass without washing to 99.1% with 3 washing stages (scrub), maintaining the overall lithium extraction yield at over 90%.

TABLE 9

| | | LiCl | LiCl as | LiCl as | LiCl as |
|---|---|---|---|---|---|
| | | as | produced | produced | produced |
| | | produced | with | with | with |
| % | | without | one | two | four |
| by | | washing | washing | washing | washing |
| mass | Supply | stage | stage | stages | stages |
| Li⁺ | 0.09% | 0.72% | 0.71% | 0.63% | 0.62% |
| Na⁺ | 7.12% | 0.78% | 0.17% | 0.06% | 0.01% |
| K⁺ | 0.69% | 0.00% | 0.00% | 0.00% | 0.00% |
| Mg²⁺ | 0.61% | 0.00% | 0.00% | 0.00% | 0.00% |
| Ca²⁺ | 1.13% | 0.77% | 0.10% | 0.02% | 0.00% |
| SO₄²⁻ | 0.06% | 0.00% | 0.00% | 0.00% | 0.00% |
| Cl⁻ | 15.81% | 6.23% | 4.06% | 3.31% | 3.21% |
| Other | <1% | 0.00% | 0.00% | 0.00% | 0.00% |
| (B . . . ) | | | | | |
| TDS | 306.4 | 90.3 | 52.3 | 41.3 | 39.67 |
| (g/L) | | | | | |
| Density | 1.201 | 1.063 | 1.038 | 1.032 | 1.031 |
| (kg/L) | | | | | |
| Flow (m/ | 218 | 32.7 | 29.75 | 35.5 | 35.5 |
| h) ³ | supply | Strip | Strip | Strip | Strip |
| Li yield | / | 93.0% | 90.45% | 94.85% | 94.33% |
| Purity | 2.26% | 51.6% | 85.9% | 95.5% | 99.1% |
| LiCl | | | | | |

It appears that total salinity (TDS) decreases with increasing purity of LiCl (up to 99.09% dry weight), which also makes it possible to lower the osmotic pressure of this effluent to 47 bars, making it easier to separate the LiCl from the water for recycling.

### Compounds of Formula:

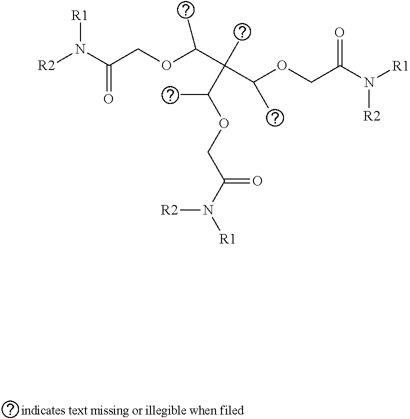

The compounds of interest are synthesized in three successive stages.

### Stage 1: Synthesis of the Secondary Amine

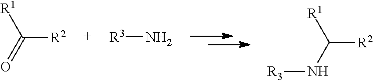

Place the ketone (10 mmol, 1 eq), solvent (17 Vol), amine (45 mmol, 4.5 eq) and reagent(s) in a clean, dry flask. Depending on the reagent, heat if necessary. The conversion is followed by TLC with the disappearance of the initial ketone. Evaporation of the solvent (and sometimes of the residual amine) under reduced pressure. Filtration if necessary over Fontainebleau sand, then addition of methanol (12 Vol). Addition by portion of NaBH₄ (30 mmol, 3 eq) if necessary, stirring for 1-15 h at RT.

Purification on silica gel if necessary. (DCM to DCM/ethyl acetate). Yield: 20-77%.

### Stage 2: Synthesis of Chloroacetamide

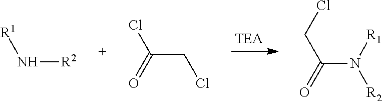

Place the previously formed amine (10 mmol, 1 eq), dichloromethane (3 Vol, 15 eq) and triethylamine (30 mmol, 3 eq) in a flask. Add chloroacetyl chloride (20-25 mmol, 2-2.5 eq) cold under an argon atmosphere. Shake at room temperature for 5-24 h. Add 2 volumes of water and carry out two counter-extractions of the aqueous phase with 2 volumes of DCM. Concentrate the organic phase in a rotary evaporator.

Purification of the product on a silica gel column (100% DCM eluent). Yield: 30-70%.

### Stage 3: Synthesis of the Compound of Interest

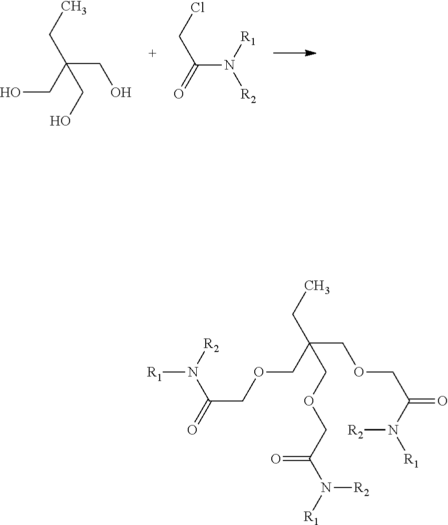

In a tricol, add NaH (3.5-4 eq) to 10 Volumes of anhydrous THF. Heat the medium to reflux under argon. Hot introduction of the triol solubilized in 10 Vol of THF followed by the synthesized chloroacetamide, solubilized in 15-20 Vol of THF. Stir the medium under reflux for 1-24 h. Neutralize the medium by adding 10 Volumes of water. Carry out two counter-extractions of the aqueous phase with 5 Volumes of DCM. Then wash the organic phase one or two times with 5 V of water. Concentrate the organic phase in a rotary evaporator.

Purify the crude obtained by chromatography on silica gel (eluent: heptane/ethyl acetate). Yields are generally between 50-70%.

Table 10 shows the formulae of the compounds as synthesized, Li VIII being renamed CE00.

TABLE 10

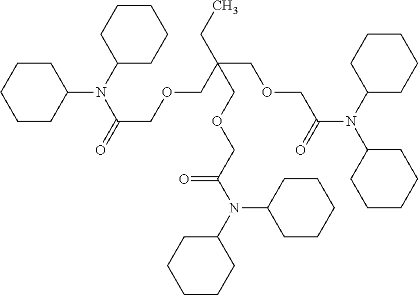 [SMILES: CCC(COCC(=O)N(C1CCCCC1)C1CCCCC1)(COCC(=O)N(C1CCCCC1)C1CCCCC1)COCC(=O)N(C1CCCCC1)C1CCCCC1]

CE00 (133338-85-9)

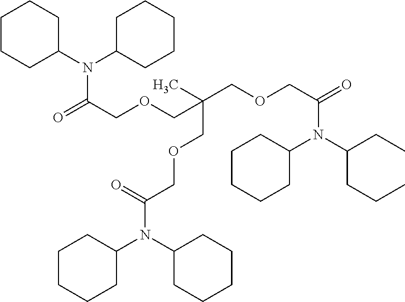 [SMILES: CCCC(CC)N(C(=O)COCC(C)(COCC(=O)N(C1CCCCC1)C1CCCCC1)COCC(=O)N(C1CCCCC1)C1CCCCC1)C1CCCCC1]

CE01

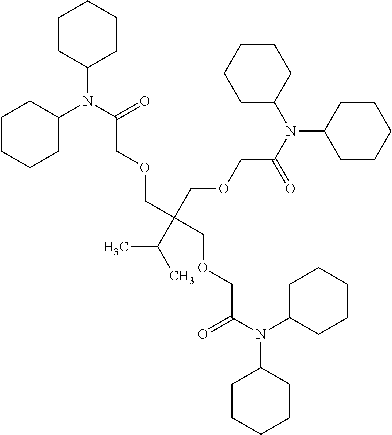 [SMILES: CC(C)C(COCC(=O)N(C1CCCCC1)C1CCCCC1)(COCC(=O)N(C1CCCCC1)C1CCCCC1)COCC(=O)N(C1CCCCC1)C1CCCCC1]

CE02

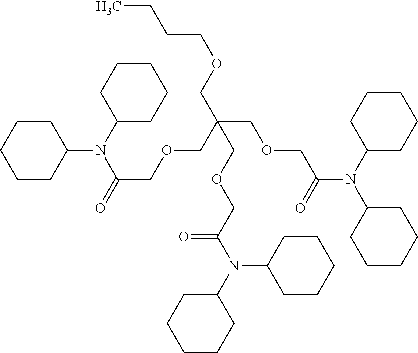 [SMILES: CCCCOCC(COCC(=O)N(C1CCCCC1)C1CCCCC1)(COCC(=O)N(C1CCCCC1)C1CCCCC1)COCC(=O)N(C1CCCCC1)C1CCCCC1]

CE03

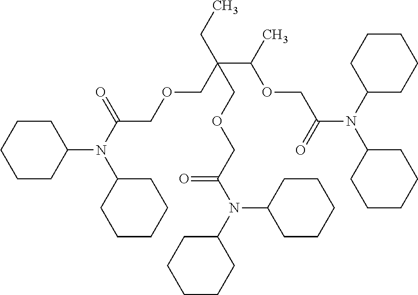 [SMILES: CCC(COCC(=O)N(C1CCCCC1)C1CCCCC1)(COCC(=O)N(C1CCCCC1)C1CCCCC1)C(C)OCC(=O)N(C1CCCCC1)C1CCCCC1]

CE04

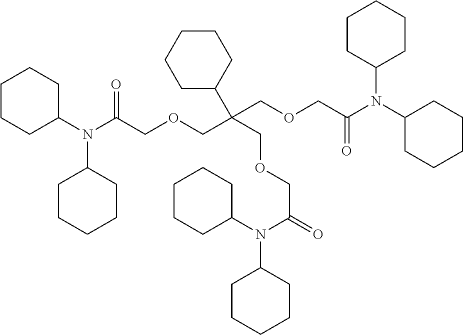 [SMILES: O=C(COCC(COCC(=O)N(C1CCCCC1)C1CCCCC1)(COCC(=O)N(C1CCCCC1)C1CCCCC1)C1CCCCC1)N(C1CCCCC1)C1CCCCC1]

CE05

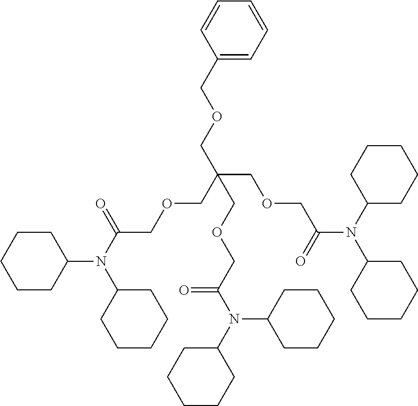 [SMILES: O=C(COCC(COCC(=O)N(C1CCCCC1)C1CCCCC1)(COCC(=O)N(C1CCCCC1)C1CCCCC1)COCc1ccccc1)N(C1CCCCC1)C1CCCCC1]

CE06

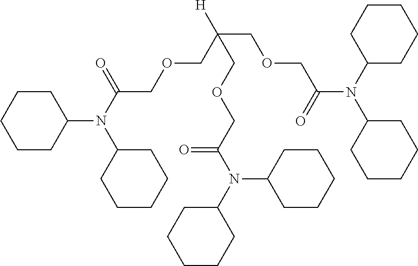 [SMILES: O=C(COCC(COCC(=O)N(C1CCCCC1)C1CCCCC1)COCC(=O)N(C1CCCCC1)C1CCCCC1)N(C1CCCCC1)C1CCCCC1]

CE07 (148303-04-2)

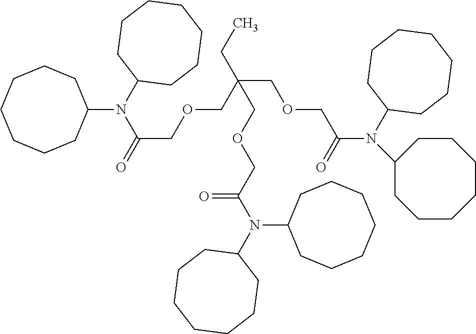 [SMILES: CCC(COCC(=O)N(C1CCCCCCC1)C1CCCCCCC1)(COCC(=O)N(C1CCCCCCC1)C1CCCCCCC1)COCC(=O)N(C1CCCCCCC1)C1CCCCCCC1]

CE08

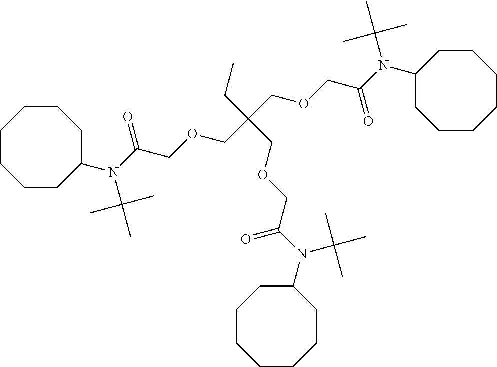 [SMILES: CCC(COCC(=O)N(C1CCCCCCC1)C(C)(C)C)(COCC(=O)N(C1CCCCCCC1)C(C)(C)C)COCC(=O)N(C1CCCCCCC1)C(C)(C)C]

CE09

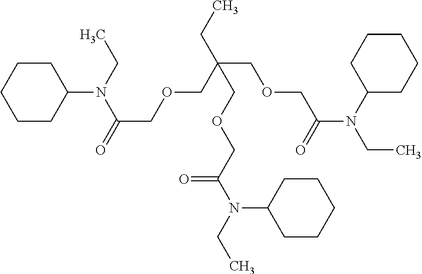 [SMILES: CCN(C(=O)COCC(CC)(COCC(=O)N(CC)C1CCCCC1)COCC(=O)N(CC)C1CCCCC1)C1CCCCC1]

CE10 (133338-84-8)

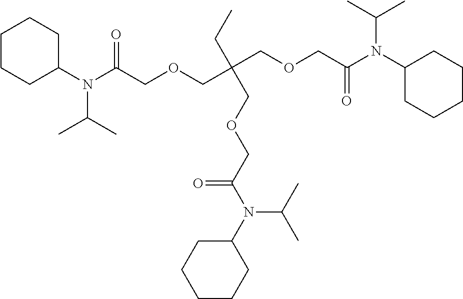 [SMILES: CCC(COCC(=O)N(C(C)C)C1CCCCC1)(COCC(=O)N(C(C)C)C1CCCCC1)COCC(=O)N(C(C)C)C1CCCCC1]

CE11

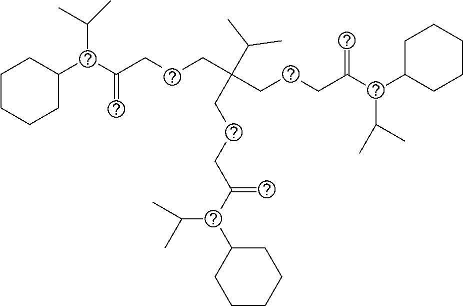 [SMILES: C=C(CCCC(CCCC(=C)C(C(C)C)C1CCCCC1)(CCCC(=C)C(C(C)C)C1CCCCC1)C(C)C)C(C(C)C)C1CCCCC1]

CE12

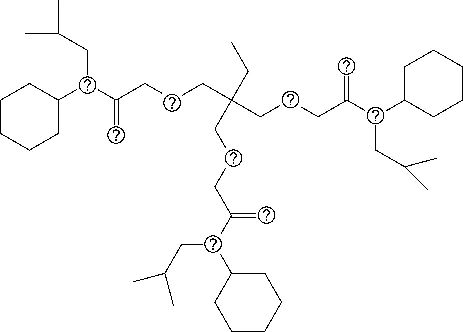 [SMILES: C=C(CCCC(CC)(CCCC(=C)C(CC(C)C)C1CCCCC1)CCCC(=C)C(CC(C)C)C1CCCCC1)C(CC(C)C)C1CCCCC1]

CE13

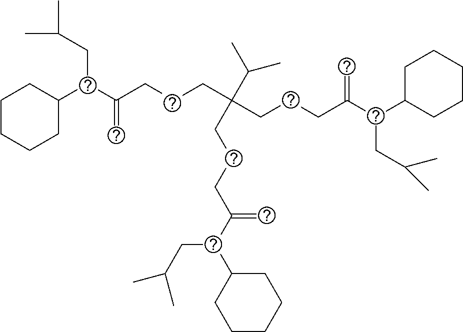 [SMILES: C=C(CCCC(CCCC(=C)C(CC(C)C)C1CCCCC1)(CCCC(=C)C(CC(C)C)C1CCCCC1)C(C)C)C(CC(C)C)C1CCCCC1]

CE14

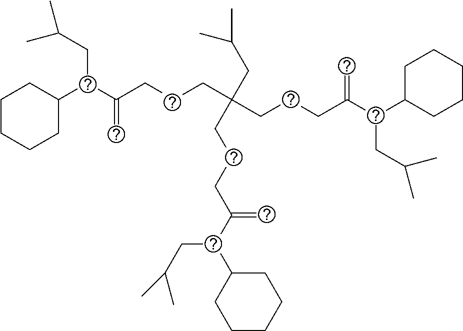 [SMILES: C=C(CCCC(CCCC(=C)C(CC(C)C)C1CCCCC1)(CCCC(=C)C(CC(C)C)C1CCCCC1)CC(C)C)C(CC(C)C)C1CCCCC1]

CE15

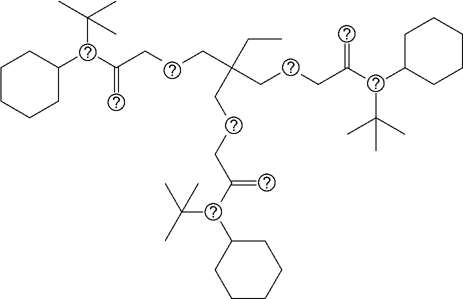 [SMILES: C=C(CCCC(CC)(CCCC(=C)C(C1CCCCC1)C(C)(C)C)CCCC(=C)C(C1CCCCC1)C(C)(C)C)C(C1CCCCC1)C(C)(C)C]

CE16

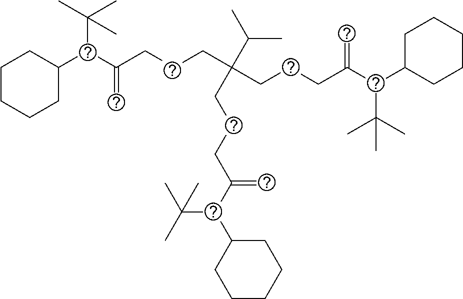 [SMILES: C=C(CCCC(CCCC(=C)C(C1CCCCC1)C(C)(C)C)(CCCC(=C)C(C1CCCCC1)C(C)(C)C)C(C)C)C(C1CCCCC1)C(C)(C)C]

CE17

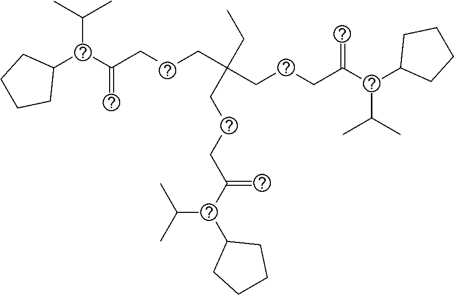 [SMILES: C=C(CCCC(CC)(CCCC(=C)C(C(C)C)C1CCCC1)CCCC(=C)C(C(C)C)C1CCCC1)C(C(C)C)C1CCCC1]

CE18

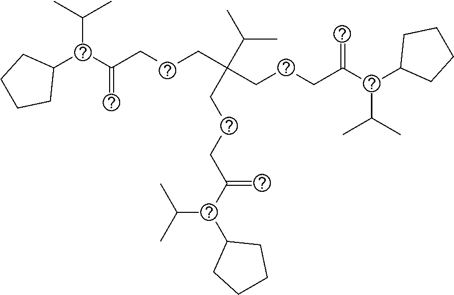 [SMILES: C=C(CCCC(CCCC(=C)C(C(C)C)C1CCCC1)(CCCC(=C)C(C(C)C)C1CCCC1)C(C)C)C(C(C)C)C1CCCC1]

CE19

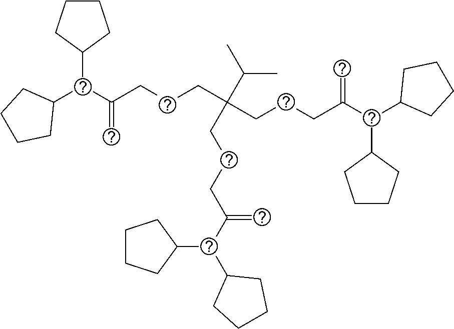 [SMILES: C=C(CCCC(CCCC(=C)C(C1CCCC1)C1CCCC1)(CCCC(=C)C(C1CCCC1)C1CCCC1)C(C)C)C(C1CCCC1)C1CCCC1]

CE20

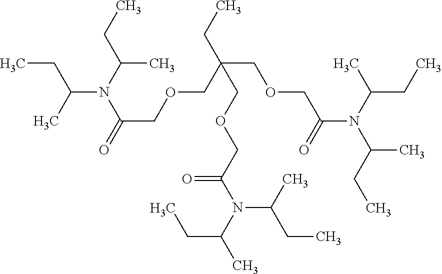 [SMILES: CCC(C)N(C(=O)COCC(CC)(COCC(=O)N(C(C)CC)C(C)CC)COCC(=O)N(C(C)CC)C(C)CC)C(C)CC]

CE21

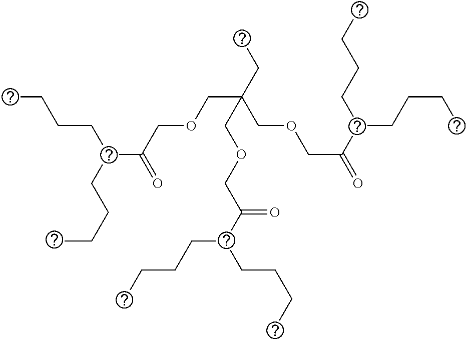 [SMILES: CCCCC(CCCC)C(=O)COCC(CC)(COCC(=O)C(CCCC)CCCC)COCC(=O)C(CCCC)CCCC]

CE22 (148303-04-2)

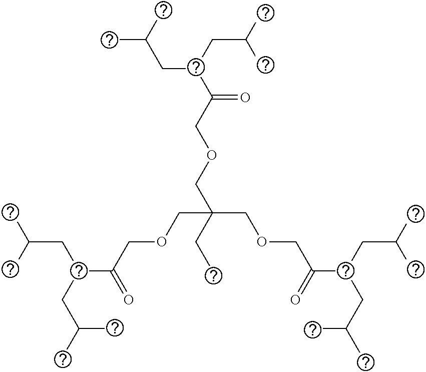 [SMILES: CCC(COCC(=O)C(CC(C)C)CC(C)C)(COCC(=O)C(CC(C)C)CC(C)C)COCC(=O)C(CC(C)C)CC(C)C]

CE23 (746656-32-6)

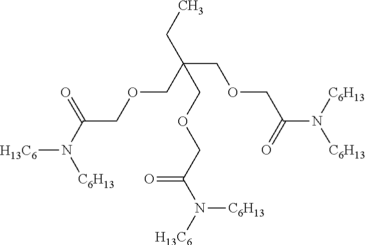

CE24

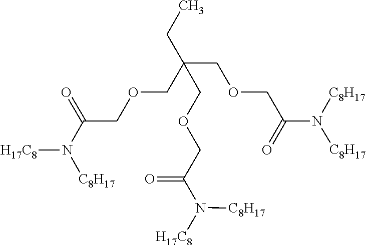

CE25

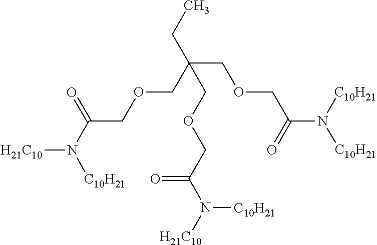

CE26

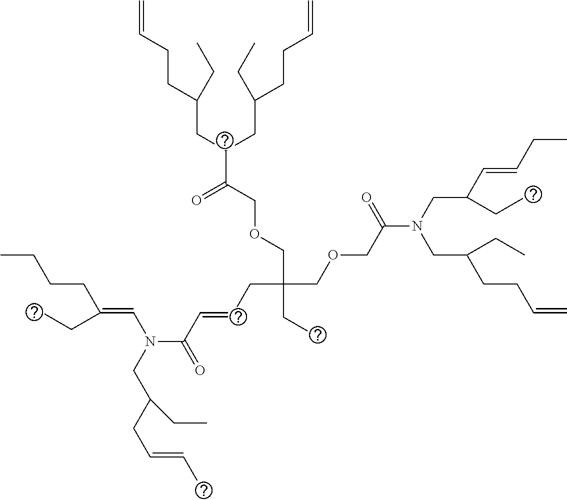 [SMILES: C=CCCC(CC)CC(CC(CC)CCC=C)C(=O)COCC(CC)(C/C=C/C(=O)N(/C=C(\CC)CCCC)CC(CC)C/C=C/C)COCC(=O)N(CC(/C=C/CC)CC)CC(CC)CCC=C]

CE27

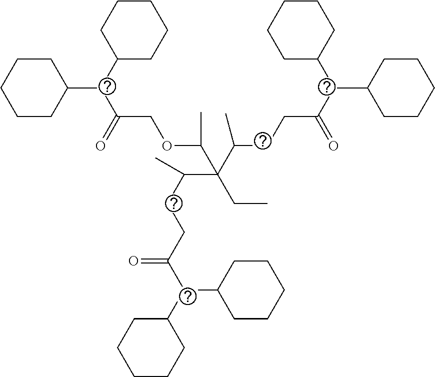 [SMILES: CCC(C(C)CCC(=O)C(C1CCCCC1)C1CCCCC1)(C(C)CCC(=O)C(C1CCCCC1)C1CCCCC1)C(C)OCC(=O)C(C1CCCCC1)C1CCCCC1]

CE28

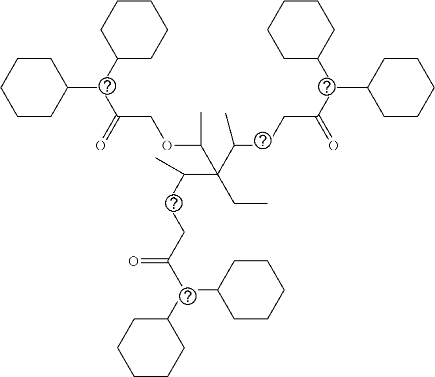 [SMILES: CCC(C(C)CCC(=O)C(C1CCCCC1)C1CCCCC1)(C(C)CCC(=O)C(C1CCCCC1)C1CCCCC1)C(C)OCC(=O)C(C1CCCCC1)C1CCCCC1]

CE29

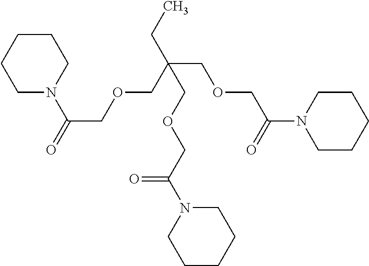 [SMILES: CCC(COCC(=O)N1CCCCC1)(COCC(=O)N1CCCCC1)COCC(=O)N1CCCCC1]

CE30 (405264-17-7)

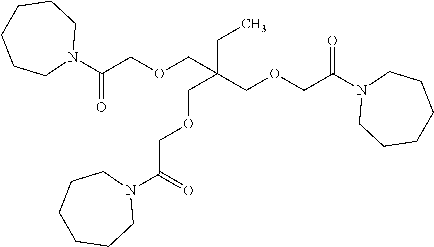 [SMILES: CCC(COCC(=O)N1CCCCCC1)(COCC(=O)N1CCCCCC1)COCC(=O)N1CCCCCC1]

CE31

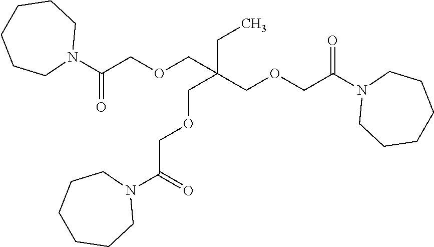 [SMILES: CCC(COCC(=O)N1CCCCCC1)(COCC(=O)N1CCCCCC1)COCC(=O)N1CCCCCC1]

CE32

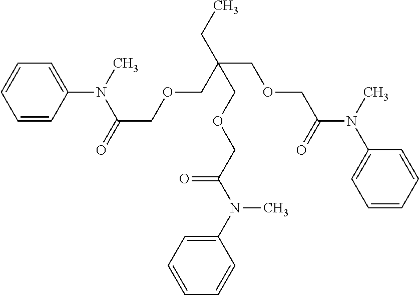 [SMILES: CCC(COCC(=O)N(C)c1ccccc1)(COCC(=O)N(C)c1ccccc1)COCC(=O)N(C)c1ccccc1]

CE33 (405264-15-5)

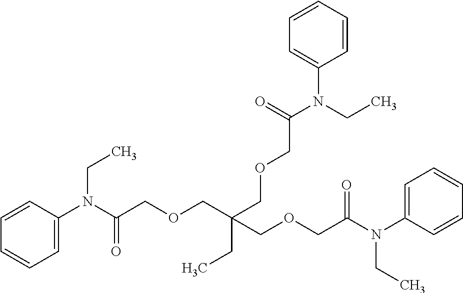 [SMILES: CCN(C(=O)COCC(CC)(COCC(=O)N(CC)c1ccccc1)COCC(=O)N(CC)c1ccccc1)c1ccccc1]

CE34 (405264-16-6)

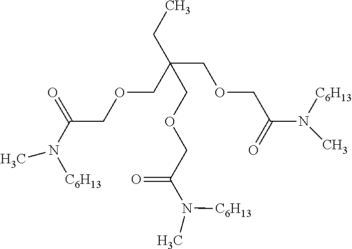

CE35

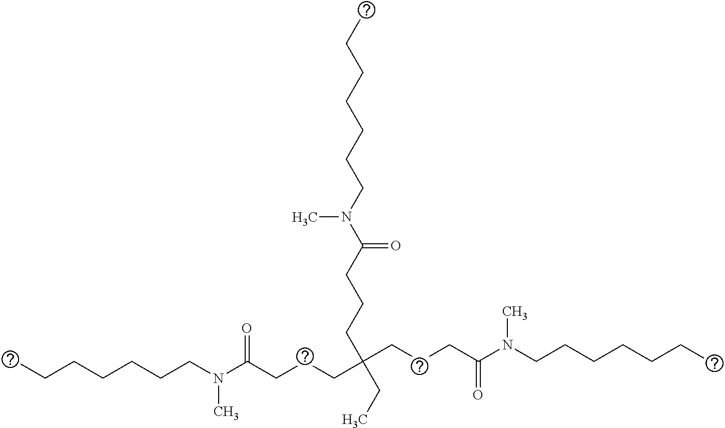 [SMILES: CCCCCCCN(C)C(=O)CCCC(CC)(CCCC(=O)N(C)CCCCCCC)CCCC(=O)N(C)CCCCCCC]

CE36 (61183-76-4)

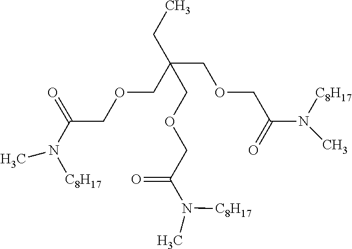

CE37

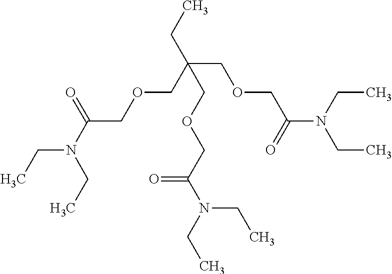 [SMILES: CCN(CC)C(=O)COCC(CC)(COCC(=O)N(CC)CC)COCC(=O)N(CC)CC]

CE38

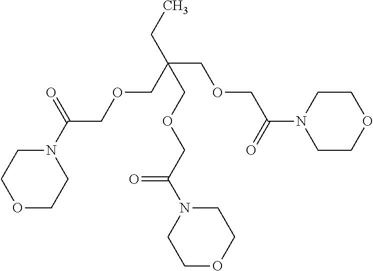 [SMILES: CCC(COCC(=O)N1CCOCC1)(COCC(=O)N1CCOCC1)COCC(=O)N1CCOCC1]

CE39

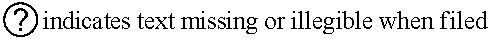

Tables 11 and 12 show the characteristics of the compounds as synthesized.

TABLE 11

| Code | | | | Mw | Melt | | | | | | | |
|---|---|---|---|---|---|---|---|---|---|---|---|---|
| N° | CE Simplified Name | Raw Formula | CAS N° | (g/mol) | Point | | R1 | R2 | R3 | R4 | R5 | R6 |
| CE00 | Ethyl-N(CyHex)2 | C48H83N3O6 | 133338-85-9 | 798.19 | 130° | C. | Cyclohexyl | Cyclohexyl | Ethyl | H | H | H |
| CE01 | Methyl-N(CyHex)2 | C47H81N3O6 | Unknown | 784.16 | 90° | C. | Cyclohexyl | Cyclohexyl | Methyl | H | H | H |
| CE02 | i-Prop-N(CyHex)2 | C49H85N3O6 | Unknown | 812.23 | 176° | C. | Cyclohexyl | Cyclohexyl | Iso-Propyl | H | H | H |
| CE03 | n-Butyl-OC-N(CyHex)2 | C51H89N3O7 | Unknown | 856.27 | 142° | C. | CycloHexyl | CycloHexyl | MeOButyl | H | H | H |
| CE04 | 1-Me-Et-N(CyHex)2 | C49H85N3O6 | Unknown | 812.22 | 75° | C. | Cyclohexyl | Cyclohexyl | Ethyl | Methyl | H | H |
| CE05 | CyHex-N(CyHex)2 | C52H89N3O6 | Unknown | 852.28 | 89.5° | C. | CycloHexyl | CycloHexyl | CycloHexyl | H | H | H |
| CE06 | PhCOC-N(CyHex)2 | C54H87N3O7 | Unknown | 890.28 | 196.5 | | CycloHexyl | CycloHexyl | MeOBenzyl | H | H | H |
| CE07 | H-N(CyHex)2 | C46H79N3O6 | 148303-04-2 | 770.14 | 167° | C. | CycloHexyl | CycloHexyl | H | H | H | H |
| CE08 | Ethyl-N(CyOct)2 | C60H107N3O6 | Unknown | 966.53 | oil | | CycloOctyl | CycloOctyl | Ethyl | H | H | H |
| CE09 | Ethyl-N(CyOct, t-But) | C48H89N3O6 | Unknown | 804.24 | oil | | CycloOctyl | tert-Butyl | Ethyl | H | H | H |
| CE10 | Ethyl-N(CyHex, Et) | C36H65N3O6 | 133338-84-8 | 635.92 | oil | | CycloHexyl | Ethyl | Ethyl | H | H | H |
| CE11 | Ethyl-N(CyHex, iProp) | C39H71N3O6 | Unknown | 677.99 | oil | | Cyclohexyl | Iso-propyl | Ethyl | H | H | H |
| CE12 | i-Prop-N(CyHex, i-Prop) | C42H77N3O6 | Unknown | 720.08 | oil | | Cyclohexyl | Iso-propyl | Iso-propyl | H | H | H |
| CE13 | Ethyl-N(CyHex, i-But) | C42H77N3O6 | Unknown | 720.08 | oil | | Cyclohexyl | Iso-butyl | Ethyl | H | H | H |
| CE14 | i-Prop-N(CyHex, i-But) | C43H79N3O6 | Unknown | 734.12 | oil | | Cyclohexyl | Iso-butyl | Iso-propyl | H | H | H |
| CE15 | i-But-N(CyHex, i-But) | C44H81N3O6 | Unknown | 748.14 | oil | | Cyclohexyl | Iso-butyl | Iso-Butyl | H | H | H |
| CE16 | Ethyl-N(CyHex, t-But) | C42H77N3O6 | Unknown | 720.08 | oil | | Cyclohexyl | tert-Butyl | Ethyl | H | H | H |
| CE17 | i-Prop-N(CyHex, t-But) | C43H79N3O6 | Unknown | 734.12 | oil | | Cyclohexyl | tert-Butyl | Iso-propyl | H | H | H |
| CE18 | Ethyl-N(CyPen, i-Prop) | C36H65N3O6 | Unknown | 635.93 | oil | | Cyclopentyl | Iso-propyl | Ethyl | H | H | H |
| CE19 | i-Prop-N(CyPen, i-Prop) | C37H67N3O6 | Unknown | 649.96 | oil | | Cyclopentyl | Iso-propyl | Iso-propyl | H | H | H |
| CE20 | i-Prop-N(CyPen)2 | C43H73N3O6 | Unknown | 728.07 | 95° | C. | Cyclopentyl | Cyclopentyl | Iso-propyl | H | H | H |

| | | | | | | | | | | | |
|---|---|---|---|---|---|---|---|---|---|---|---|
| CE21 | Ethyl-N(s-But)2 | C36H71N3O6 | Unknown | 641.95 | oil | Sec-butyl | Sec-butyl | Ethyl | H | H | H |
| CE22 | Ethyl-N(n-But)2 | C36H71N3O6 | 148303-04-2 | 641.95 | oil | n-butyl | n-butyl | Ethyl | H | H | H |
| CE23 | Ethyl-N(i-But)2 | C36H71N3O6 | 746656-32-6 | 641.95 | oil | i-Butyl | i-Butyl | Ethyl | H | H | H |
| CE24 | Ethyl-N(n-Hex)2 | C48H95N3O6 | Unknown | 810.26 | oil | n-Hexyl | n-Hexyl | Ethyl | H | H | H |
| CE25 | Ethyl-N(n-Oct)2 | C60H119N3O6 | Unknown | 978.60 | oil | n-Octyl | n-Octyl | Ethyl | H | H | H |

TABLE 12

| Code | | | | Mw | Melt | | | | | | |
|---|---|---|---|---|---|---|---|---|---|---|---|
| N° | CE Simplified Name | Raw Formula | CAS N° | (g/mol) | Point | R1 | R2 | R3 | R4 | R5 | R6 |
| CE26 | Ethyl-N(n-Dec)2 | C72H143N3O6 | Unknown | 1146.92 | oil | n-decyl | n-decyl | Ethyl | H | H | H |
| CE27 | Ethyl-N(2-EtHex)2 | C60H119N3O6 | Unknown | 978.62 | oil | 2-Ethyl- | 2-Ethyl- | Ethyl | H | H | H |
| | | | | | | Hexyl | Hexyl | | | | |
| CE28 | (1-Me)3-Et-N(CyHex)2 | C51H89N3O6 | Unknown | 840.00 | / | CycloHexyl | CycloHexyl | Ethyl | Methyl | Methyl | Methyl |
| CE29 | (1-Me)2-Et-N(CyHex)2 | C50H87N3O6 | Unknown | 826.24 | / | CycloHexyl | CycloHexyl | Ethyl | Methyl | Methyl | H |
| CE30 | Ethyl-Npiperidine | C27H47N3O6 | 405264-17-7 | 509.68 | oil | Piperidine | | Ethyl | H | H | H |
| CE31 | Ethyl-N(Azepane) | C30H53N3O6 | Unknown | 551.77 | oil | Azepane | | Ethy | H | H | H |
| CE32 | Ethyl-N(Azocan) | C33H59N3O6 | Unknown | 593.85 | oil | Azocan | | Ethy | H | H | H |
| CE33 | Ethyl-N(Phenyl, Me) | C33H41N3O6 | 405264-15-5 | 575.69 | oil | Phenyl | Methyl | Ethyl | H | H | H |
| CE34 | Ethyl-N(Ph, Me) | C36H47N3O6 | 405264-16-6 | 617.78 | oil | Phenyl | Ethyl | Ethyl | H | H | H |
| CE35 | Ethyl-N(n-Hex, Me) | C33H65N3O6 | Unknown | 599.89 | oil | n-Hexyl | Methyl | Ethyl | H | H | H |
| CE36 | Ethyl-N(n-Hept, Me) | C36H71N3O6 | 61183-76-4 | 641.97 | oil | n-Heptyl | Methyl | Ethyl | H | H | H |
| | (ETH 227 - Sodium | | | | | | | | | | |
| | Ionophore I) | | | | | | | | | | |
| CE37 | Ethyl-N(n-Oct, Me) | C39H77N3O6 | Unknown | 684.04 | oil | n-Octyl | Methyl | Ethyl | H | H | H |
| CE38 | Ethyl-N(Et)2 | C24H47N3O6 | Unknown | 473.65 | oil | Ethyl | Ethyl | Ethyl | H | H | H |

| | | | | | | | | | | |
|---|---|---|---|---|---|---|---|---|---|---|
| CE39 | Ethyl-N(Morpholine) | C24H41N3O9 | Unknown | 515.60 | oil | Morpholine | Ethyl | H | H | H |

(Me = Methyl)

1- A process for the selective extraction of a salt to be extracted comprising at least one cation and at least one anion from a salt water or brine to be treated containing the salt to be extracted and salts other than the salt to be extracted, wherein:
the brine to be treated is sent to a so-called initial extraction stirrer-mixer into which a liquid hydrophobic organic phase is also introduced, the organic phase comprising:
at least a first hydrophobic, protic organic compound which solvates the anion of the salt to be extracted and whose pKa in water at 25° C. is at least 9; and
at least a second hydrophobic organic compound which selectively extracts the cation of the salt to be extracted and has a complexation constant for the cation to be extracted whose log K value, in methanol at 25° C., is greater than 1,
the brine and the liquid hydrophobic organic phase are mixed in the extraction stirrer-mixer, and the mixture is sent to a so-called initial extraction decanter-separator, in order to obtain:
a brine from which salt to be extracted has been removed; and
an organic phase loaded with salt to be extracted;
the brine from which the salt to be extracted has been removed is recovered;
the organic phase leaving the initial decanter-separator is sent to a new stirrer-mixer so-called an initial washing stirrer-mixer in which it is mixed with washing water, and the mixture is sent to a decanter-centrifugal separator so-called an initial washing decanter-centrifugal separator in order to obtain:
a purified organic phase loaded with salt to be extracted, which is sent to a so-called “organic” heat exchanger in which it is heated; and
a washing water loaded with impurities which is sent to the initial extraction stirrer-mixer;
the organic phase loaded with salt to be extracted, heated in the so-called “organic” heat exchanger, is sent to a so-called initial regeneration column in which a countercurrent exchange is carried out with hot water at a temperature higher than that of the initial brine, in order to obtain:
water containing the salt to be extracted; and
a regenerated organic phase, having lost the salt to be extracted;
the organic phase loaded with the salt to be extracted being heated in the heat exchanger by the organic phase leaving the regeneration column,
the regenerated organic phase is recycled to the initial extraction stirrer-mixer.

2- The process according to claim 1, wherein before recovering the brine from which salt to be extracted has been removed, the brine is sent to another extraction stirrer-mixer followed by an extraction decanter-separator, which receives the regenerated organic phase, in order to obtain, after decantation, a brine having even less salt to be extracted, which is recovered or sent again to another extraction stirrer-mixer followed by an extraction decanter-separator in order to obtain a brine having even less salt to be extracted than previously, the said operation of extracting the salt to be extracted from the brine can be repeated at least once, and the organic phase loaded with salt to be extracted is returned from a given decanter-separator to the lower-level stirrer-mixer in order to recover, at the outlet of the initial decanter-separator, the organic phase loaded with salt which is sent to the so-called “organic” heat exchanger.

3- The process according to claim 1, wherein at least another regeneration column is provided, connected in parallel with the initial regeneration column, which is supplied with a part of the flow coming from the so-called “organic” heat exchanger.

4- The process according to claim 1, wherein the at least one regeneration column(s) is (are) chosen from stirred column(s) and pulsed column(s).

5- The process according to claim 1, wherein the water which is to serve as regeneration water is sent into a so-called “water” heat exchanger in which it is heated by the water loaded with salt to be extracted leaving the at least one regeneration column, in order to obtain heated regeneration water which can be heated further before being introduced into the at least one regeneration column, and cooled water loaded with salt to be extracted is obtained from the heat exchanger.

6- The process according to claim 1, wherein, before being sent to the initial extraction stirrer-mixer, the washing water loaded with impurities is sent to a purification unit in order to obtain:
a retentate or concentrate or raffinate brine which is sent to the initial extraction stirrer-mixer; and
a purified water, which is fed back to the initial washing stirrer-mixer.

7- The process according to claim 1, wherein, before sending the washed organic phase leaving the so-called washing decanter-separator to the so-called “organic” heat exchanger, the washed organic phase is sent to another so-called washing stirrer-mixer followed by a so-called washing decanter-centrifugal separator which receives washing water, in order to obtain, after decantation, an organic phase which has undergone a further washing step which is sent to the so-called “organic” heat exchanger, it being possible for the said operation of washing the organic phase to be repeated at least once more, and the washing water loaded with impurities, or the retentate or concentrate or raffinate brine, is returned, after purification, to the initial washing stirrer-mixer.

8- The process according to claim 1, wherein the water loaded with salt to be extracted, which comes either from the at least one regeneration column or from the so-called “water” heat exchanger, is sent to a purification unit in order to obtain:
a water loaded with the concentrated and purified salt to be extracted;
a purified water, which is sent either to the regeneration columns or to the so-called “water” heat exchanger.

9- The process according to claim 1, wherein a reverse osmosis unit or membrane distillation unit or an evaporation/condensation unit or a unit for the absorption of water by a temperature-regenerable organic phase or a combination of at least two of these units is used as the purification unit.

10- The process according to claim 1, characterized in that at least one of:
distilled water;
fresh water;
desalinated water; and
at least some of the water loaded with the concentrated and purified salt to be extracted from the purification unit, possibly after cooling,
is used as the washing water.

11- The process according to claim 1, wherein the initial decanter-separator and/or the washing decanter-separator(s) are decanters-centrifugal separators, allowing the removal of a phase composed of solid waste or an aqueous washout of the organic phase or the separation of a liquid two-phase medium with an aqueous phase/organic phase ratio of less than 1.0 for the initial decanter-separator and less than 0.2 for the washing decanter-separator(s).

12- The process according to claim 1, wherein the temperature difference between the extraction and regeneration stages is at least 30° C.

13- The process according to claim 1, wherein the salt to be extracted selectively is selected from sodium salts, potassium salts, lithium salts, or salts which can be selectively extractable in the presence of other salts.

14- The process according to claim 1, wherein the volume ratio between the washing water and the organic phase introduced into the so-called washing stirrer(s)-mixer(s) is between 0.01 and 0.1.

15- The process according to claim 1, wherein the volume ratio between the hot water and the organic phase introduced into the so-called regeneration column(s) is between 0.05 and 0.2.

16- The process according to claim 1, wherein the second hydrophobic organic compound which selectively extracts the cation of the salt to be extracted has complexation constant for the cation to be extracted whose log K value, in methanol at 25° C., is greater than 2.

17- The process according to claim 12, wherein the temperature difference between the extraction and regeneration stages is at least 50° C.

18- The process according to claim 13, wherein the sodium salts are chosen from NaCl, NaCN, NaNO₃, NaBr, NaI, the potassium salts are chosen from KCl, KCN, KNO₃, KBr, KI and the lithium salts are chosen from LiCl, LiCN, LiNO₃, LiBr, LiI.

19- The process according to claim 14, wherein the volume ratio between the washing water and the organic phase introduced into the so-called washing stirrer(s)-mixer(s) is between 0.03 and 0.06.

20- The process according to claim 15, wherein the volume ratio between the hot water and the organic phase introduced into the so-called regeneration column(s) is between 0.08 and 0.15.
